(19) United States
(12) Patent Application Publication
(10) Pub. No.: US 2025/0300904 A1
(43) Pub. Date: Sep. 25, 2025

(54) ADAPTIVE MANAGEMENT SYSTEM FOR IOT NETWORKS UTILIZING DYNAMIC FUZZY LOGIC FRAMEWORK

(71) Applicant: Leptude, Inc., Austin, TX (US)

(72) Inventor: John A. Fortkort, Austin, TX (US)

(21) Appl. No.: 19/088,981

(22) Filed: Mar. 24, 2025

Related U.S. Application Data
(60) Provisional application No. 63/569,170, filed on Mar. 24, 2024.

(51) Int. Cl. H04L 41/16; H04L 41/0823; H04L 43/08; H04L 67/12

(52) U.S. Cl. CPC H04L 41/16; H04L 41/0823; H04L 43/08; H04L 67/12

(57) ABSTRACT

A system is provided for managing Internet of Things (IoT) networks. The system includes a learning module configured to employ machine learning models with hyperparameters optimized through a hyperparameter optimization process; wherein the process includes evaluating a set of hyperparameters against a performance metric to select optimal hyperparameters that enhance the adaptability and efficiency of dynamic membership functions within an adaptive fuzzy logic engine (AFLE).

### CROSS-REFERENCE TO RELATED APPLICATIONS

This application claims the benefit of U.S. provisional application No. 63/569,170 filed Mar. 24, 2024, having the same title and the same inventor, and which is incorporated herein by reference in its entirety.

### FIELD OF THE DISCLOSURE

The present application relates generally to IoT networks, and more particularly to systems and methods for managing such networks with an adaptive fuzzy logic engine that is configured to utilize dynamic membership functions for decision-making regarding network management tasks.

### BACKGROUND OF THE DISCLOSURE

Adaptive and intelligent control systems are advanced methodologies within control engineering that employ computational intelligence to manage and optimize complex systems dynamically. These systems are designed to automatically adjust their behavior in response to changes in the environment or system itself, enhancing performance, reliability, and efficiency.

Adaptive control systems specifically modify their parameters in real-time to maintain optimal performance despite external disturbances or internal system changes. They rely on feedback mechanisms to adjust control strategies based on observed conditions.

Intelligent control systems incorporate artificial intelligence techniques, such as neural networks, fuzzy logic, and machine learning algorithms, to make informed decisions. These systems are capable of handling uncertainty, learning from past experiences, and making complex decisions that mimic human reasoning.

The combination of adaptive and intelligent control enables the development of highly flexible and autonomous systems that can perform optimally under varying conditions, making them particularly useful in areas such as robotics, autonomous vehicles, smart grids, and industrial process control.

Various systems applying adaptive and intelligent control have been proposed in the art. Some of these systems utilize fuzzy logic, neural networks, and metaheuristic algorithms, to improve performance and manage disturbances in specific infrastructure systems.

For example, Hewei et al., “Adaptive Fuzzy-Logic Traffic Control Approach Based on Volunteer IoT Agent Mechanism”, introduces a traffic light control system using fuzzy logic and IoT agents for real-time traffic management. It emphasizes adaptive traffic light timing based on traffic conditions, saturation, queue length, and IoT agent feedback. The system's design and operational mechanisms, including fuzzy inference, membership function adjustments, and decision-making processes, uses real-time data and fuzzy logic for dynamic adaptation.

Aimtongkham et al. “Congestion Control and Prediction Schemes Using Fuzzy Logic System with Adaptive Membership Function in Wireless Sensor Networks”, discusses a framework for congestion control in wireless sensor networks (WSNs) that employs fuzzy logic with adaptive membership functions for path determination, focusing on optimizing network throughput, reducing packet loss, and balancing energy consumption. The system predicts and manages congestion by dynamically adjusting routing paths based on factors such as hop count, remaining energy, buffer occupancy, and forwarding rates, optimized using a bat algorithm for tuning membership functions in the fuzzy logic system.

Kumar et al., “Optimized Neural Network and Adaptive Neuro-Fuzzy Controlled Dynamic Voltage Restorer for Power Quality Performance”, presents a hybrid approach combining neural network training (NNT) based on machine learning (ML) estimators, inspired by artificial neural networks (ANN) and self-adaptive neuro-fuzzy inference systems (ANFIS), to address voltage issues in power distribution networks. This approach employs particle swarm optimization (PSO) to achieve an optimal prediction model by modifying training algorithm parameters. The focus is on improving the dynamic performance of systems facing parametric changes or external disturbances, using intelligent techniques over conventional controllers for tuning processes. The effectiveness of the controllers is validated through statistical tools, demonstrating that the ANFIS-PSO network model may achieve better DC voltage regulation performance compared to conventional PI controllers. The study highlights the advantages of incorporating intelligence-based strategies for faster convergence speed and reliable prediction rates in dynamic response improvement, utilizing MATLAB/SIMULINK for implementation.

### BRIEF DESCRIPTION OF THE DRAWINGS

FIG. 1 is an illustration of an IoT network management system.

FIG. 2 is an illustration of an AFLE.

FIG. 3 is a flowchart illustrating a method for using machine learning algorithms to refine the membership functions and decision-making rules of the AFLE in an IoT network.

FIG. 4 is a flowchart illustrating a method for using machine learning algorithms to refine the membership functions and decision-making rules of the AFLE in an IoT network.

FIG. 5 is a flowchart depicting a system for managing Internet of Things (IoT) networks adapted for use in a smart city IoT network management platform.

FIG. 6 is a flowchart depicting an autonomous network adjustment system for Internet of Things (IoT) networks adapted for use in a “Smart Factory” scenario.

FIG. 7 is a flowchart depicting a system for managing Internet of Things (IoT) networks adapted for use in a smart agriculture environment.

### SUMMARY OF THE DISCLOSURE

In one aspect, a system for managing Internet of Things (IoT) networks is provided. The system comprises a network performance monitor configured to collect real-time data on network performance metrics and contextual information; an adaptive fuzzy logic engine (AFLE) configured to utilize dynamic membership functions for decision-making regarding network management tasks based on input from the network performance monitor; a learning module configured to adapt the membership functions and rules of the AFLE based on the outcomes of decisions to optimize future network performance; and an action executor configured to implement the decisions made by the AFLE to adjust network configurations.

In another aspect, a method for dynamic management of IoT networks is provided. The method comprises collecting real-time data on network performance and contextual information; utilizing dynamic membership functions within a fuzzy logic framework to make decisions regarding network management tasks based on the collected data; adapting the membership functions and rules based on the outcomes of the decisions to optimize future network performance; and implementing the decisions to adjust network configurations.

In a further aspect, an autonomous network adjustment system for Internet of Things (IoT) networks is provided, comprising a data aggregation module that collects and processes real-time and historical network data; an adaptive decision-making unit equipped with a fuzzy logic-based processing core that dynamically updates its decision-making criteria based on the aggregated data; a network execution module that autonomously implements network configuration adjustments as determined by the decision-making unit; and a predictive analytics module that forecasts future network conditions and requirements using machine learning algorithms.

In still another aspect, a method for optimizing IoT network operations is provided, comprising continuously monitoring network performance and environmental factors affecting network operations; generating real-time decisions through an adaptive control mechanism that utilizes fuzzy logic for real-time decision-making, where the adaptive control mechanism adjusts its operational logic based on feedback from implemented decisions; and executing network adjustments through a distributed execution framework which applies the decisions generated by the adaptive control mechanism; and using a feedback loop to refine the adaptive decision-making process of the adaptive control mechanism by integrating outcomes from previous adjustments.

In yet another aspect, a system for managing devices and traffic on an IoT network is provided, comprising sensors distributed across the IoT network for real-time monitoring of device status and network traffic conditions; an adaptive management engine that processes inputs from the sensors using a fuzzy logic framework to generate device and traffic management directives, wherein the adaptive management engine includes a learning component that updates the engine's processing logic based on historical data and outcomes analysis; and a device and traffic control module that implements the directives.

In another aspect, an IoT network configuration system is provided, comprising a network analysis tool that evaluates current network configurations and performance metrics; a configuration optimization engine that uses an adaptive fuzzy logic approach to determine optimal network settings; and a configuration implementation tool that applies the optimized settings across the network, wherein the optimization engine simulates the impact of potential configuration changes on network performance before implementation.

In another aspect, a system for managing Internet of Things (IoT) networks is provided, comprising a learning module configured to employ machine learning models with hyperparameters optimized through a hyperparameter optimization process; wherein said process includes evaluating a set of hyperparameters against a performance metric to select optimal hyperparameters that enhance the adaptability and efficiency of dynamic membership functions within an adaptive fuzzy logic engine (AFLE).

In another aspect, a system is provided for dynamically managing blockchain resources in a permissionless network. The system comprises an adaptive fuzzy logic engine (AFLE) configured to (a) receive real-time blockchain metrics, including transaction backlog, block production rate, and fee data, (b) utilize dynamic membership functions to classify network load states, including at least one membership function for high congestion, and (c) generate reconfiguration commands to adjust transaction throughput parameters or fee schedules based on fuzzy rule inferences; a learning module that refines the dynamic membership functions and fuzzy rules through iterative analysis of historical on-chain events, thereby identifying effective policy adjustments for reducing latency and preventing mempool overload; and an execution layer deployed on multiple validating nodes, each node implementing the reconfiguration commands in substantially real time to balance network throughput and resource usage without disrupting consensus.

In a further aspect, a system for multi-layer blockchain coordination is provided. The system comprises a cross-layer data aggregator that collects performance metrics from at least one layer-1 (L1) blockchain and one layer-2 (L2) or sidechain, wherein said metrics include at least one metric selected from the group consisting of gas fee levels, aggregator status, and bridging throughput; an adaptive fuzzy logic engine (AFLE) configured to maintain layer-specific membership function subsets mapping each blockchain's state into fuzzy sets for network load or transaction finality; a weighted aggregation mechanism within the AFLE that prioritizes bridging or settlement operations in response to fuzzy classifications of resource constraints on each layer; and a distributed gateway layer adapted to execute bridging updates or batch confirmations based on AFLE outputs, ensuring that bridging frequency and batch size are dynamically revised to avoid network bottlenecks or excessive fees on either chain.

In another aspect, a method for adaptively managing validator incentives and security in a proof-of-stake or proof-of-authority blockchain is provided. The method comprises collecting validator performance data, including data selected from the group consisting of resource consumption, missed block counts, and contradictory proposal events; applying an adaptive fuzzy logic engine which defines dynamic membership functions for at least (i) validator efficiency and (ii) consensus participation, and which updates said membership functions based on observed performance variations; computing fuzzy inferences that assign each validator a real-time effectiveness or security posture score; adjusting block reward parameters or imposing slashing penalties for underperforming or anomalous validators whenever said fuzzy inference crosses a threshold indicative of consistent idle behavior or malicious intent; and wherein a learning module refines the membership functions by analyzing historical validator outcomes to improve accuracy in identifying suboptimal or malicious nodes, thereby enhancing network security and fairness in reward distribution.

In another aspect, a system is provided for adaptive data placement in decentralized storage networks. The system comprises node telemetry software deployed across plural storage nodes, each collecting metrics on disk capacity, bandwidth availability, or historical retrieval latency; an adaptive fuzzy logic engine (AFLE) configured to define membership functions for node storage status, replication factor, or retrieval performance, wherein said membership functions are updated in real-time to reflect node churn or bandwidth changes; fuzzy rules weighting physical layer data (disk usage), network layer data (connectivity), and application patterns (regional retrieval requests) to generate adaptive block placement directives; and a distributed orchestration module that enforces partial replication or block movement among storage nodes, based on outputs from the AFLE, ensuring that data is placed according to dynamic fuzzy priorities balancing reliability and retrieval latency.

In another aspect, a system for decentralized identity and reputation scoring in a Web3 environment. The system comprises an identity oracle capable of aggregating user data from on-chain transactions, governance participation, and optionally off-chain signals; an adaptive fuzzy logic engine (AFLE) that categorizes each user's trustworthiness into “high,” “medium,” or “low” fuzzy sets, dynamically adjusting membership function boundaries as new event logs are received; a learning module configured to identify patterns of suspicious on-chain behavior (such as blacklisted address interactions) and rapidly shift a user's fuzzy classification to a lower trust level upon correlating multiple negative signals; and one or more consensus-level hooks or smart contracts that restrict, isolate, or require extra authentication for users whose fuzzy trust metric falls below a threshold, thereby promoting real-time, data-driven identity adaptation in permissionless networks.

In a further aspect, a method is provided for adaptively managing DAO governance parameters. The method comprises collecting DAO engagement data including user turnout, token distribution, and proposal content complexity; applying a fuzzy logic engine that defines membership functions for at least “community participation” and “proposal urgency,” updating said membership functions based on time-varying engagement patterns; automatically adjusting quorum or voting thresholds for proposals whose fuzzy classification indicates high risk or low user turnout, thus requiring additional votes or extended deadlines; wherein a learning module analyzes historical voting outcomes to highlight key proposal factors (e.g., token redistribution) that consistently increase community contention, and reweights the fuzzy membership functions to emphasize economic tension for these proposals; and thereby enabling the DAO to maintain a real-time, adaptive governance process that scales decision-making requirements with observed engagement and proposal complexity.

### DETAILED DESCRIPTION

While the foregoing systems may have some advantages, they do not adequately address a number of needs that currently persist in the art. There is thus a need for systems and methodologies which address these shortcomings.

For example, the systems in these references focus on specific aspects of power quality and traffic control within more narrowly defined contexts, such as dynamic voltage restoration in power distribution networks, congestion control in wireless sensor networks, and traffic light timing optimization. While such systems may be of some utility, they do not address the broader scope of IoT network management, including device configuration, network optimization, and diverse application requirements. Similarly, while the systems in these references may represent solutions for specific scenarios using real-time data, they do not provide a means to improve or optimize network performance across various metrics relevant to IoT applications. Likewise, while the systems described in these references may involve adaptive techniques and learning for specific tasks, such as voltage restoration and congestion control, they do not suggest how a system may be developed that learns and adapts across the broad spectrum of network management tasks typically encountered in IoT contexts, nor do they provide solutions which encompass a wider array of network configurations and optimizations tailored to diverse IoT applications.

These and other needs may be met with the systems and methodologies disclosed herein. In a preferred embodiment, systems and methodologies are disclosed herein for dynamic and intelligent management of IoT networks. These systems and methodologies leverage real-time data, adaptive fuzzy logic, and continuous learning to improve or optimize network performance and configuration. In an especially preferred embodiment, these systems and methodologies may be utilized to implement comprehensive systems for managing IoT networks that leverage an adaptive fuzzy logic engine (AFLE) with dynamic membership functions and a learning module for decision-making based on real-time network performance data. The resulting systems may be utilized to improve or optimize IoT network performance by continuously adapting to changing conditions and outcomes.

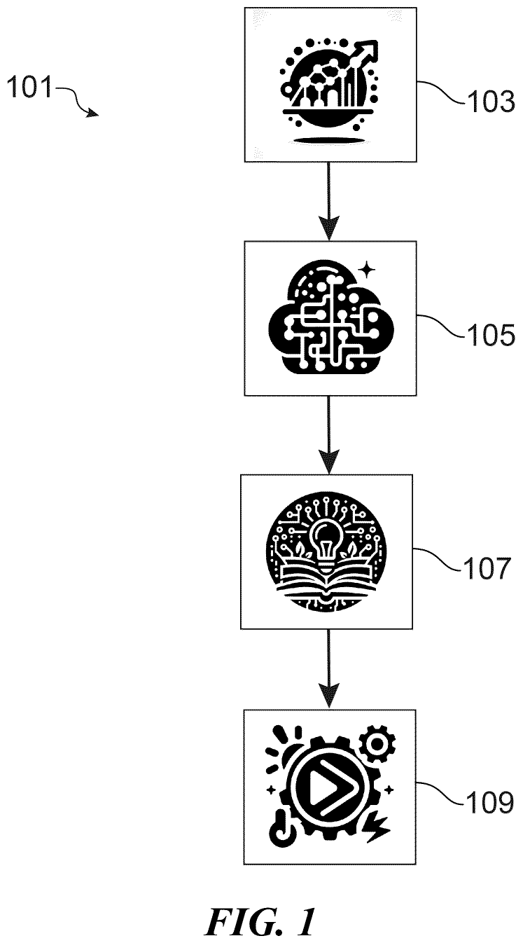

FIG. 1 depicts a particular, nonlimiting embodiment of an IoT network management system in accordance with the teachings herein. The system depicted is a sophisticated, integrated platform designed to ensure the efficient and adaptive operation of a vast and diverse array of IoT devices within a network. This system may serve as the intelligent backbone of IoT infrastructure, capable of handling dynamic changes and optimizing network performance in real-time.

The system 101 depicted therein comprises a network performance monitor 103, an adaptive fuzzy logic engine (AFLE) 105, a learning module 107 and an action executor 109.

The network performance monitor 103 acts as the system's sensory organ, constantly scanning the network to collect a wide range of data, including but not limited to, bandwidth usage, latency, error rates, and device status information. It may also gather contextual data, such as time of day, which may influence network performance and management strategies. The monitor may use a combination of embedded sensors within IoT devices, network sniffers, and software agents to gather this data, ensuring a comprehensive view of network health and performance.

The AFLE 105 forms the core of the system and utilizes fuzzy logic to interpret the complex, often ambiguous data collected by the network performance monitor. Unlike traditional binary logic, fuzzy logic allows for more nuanced decision-making, enabling the AFLE to deal with uncertainty and partial truths found in real-world scenarios. The AFLE dynamically adjusts its membership functions-mathematical curves that define how input data maps to certain degrees of membership in sets (for example, “high bandwidth usage” or “low error rate”)-based on current network conditions, facilitating more accurate and context-aware decisions.

The learning module 107 enables the system to evolve and improve over time. Using the outcomes of past decisions as a learning dataset, the module may employ machine learning algorithms to refine the membership functions and decision-making rules of the AFLE. This may involve identifying patterns in which specific network management strategies succeed or fail, thereby optimizing future performance. Techniques such as reinforcement learning, where the system learns optimal actions through trial and error, may be especially effective for this purpose.

The action executor 109 carries out the decisions of the AFLE. Those decisions may involve, for example, rerouting data to avoid congestion, adjusting the power settings on devices to save energy, or updating security protocols to thwart a detected threat. Executing these decisions may involve, for example, sending commands to network routers and switches, updating firmware on IoT devices, or adjusting the configuration of cloud services. Preferably, the executor 109 is highly secure and reliable, capable of interfacing with a diverse set of devices and platforms, and is agile enough to implement changes quickly to keep pace with the dynamic nature of IoT networks.

The interaction among the components of the proposed IoT network management system is orchestrated to ensure seamless, intelligent operation and optimization of the network. Briefly, the process flow amongst and between these components involves data collection by the network performance monitor, analysis and decision making by the AFLE, optimization by the learning module, and implementation by the action executor. These steps are described in greater detail below.

The process flow commences with the network performance monitor continuously collecting data on network performance metrics and contextual information. Such performance metrics may include, for example, bandwidth utilization, latency, and error rates. Contextual information may include, for example, device locations or time-of-day variations in network traffic. This data collection is preferably thorough, leveraging embedded sensors in IoT devices, network sniffers, and software agents distributed throughout the network to gather a comprehensive set of real-time data.

The collected data is then fed into the AFLE. This engine, designed to handle the uncertainty and vagueness inherent in real-world data, uses fuzzy logic to process the input. It assesses the current state of the network by evaluating the data against dynamically adjusted membership functions, which represent different performance states or conditions in a way that accommodates overlapping between categories (for example, “high” and “medium” bandwidth usage might not be distinct categories but rather have a degree of overlap). The AFLE makes decisions on network management tasks such as rerouting traffic, adjusting device configurations, or scaling resources based on its analysis.

Concurrently, the learning module observes the outcomes of the decisions of the AFLE and the real-time performance data and learns from successes and failures as it does so. This module applies machine learning algorithms to optimize the membership functions and decision-making rules used by the AFLE, ensuring that the decisions of the system improve over time. It identifies patterns in network conditions and outcomes to refine the decision-making process, making it more accurate and efficient.

Once a decision is made by the AFLE, the action executor component implements it across the network. This may involve sending commands to network infrastructure (like routers and switches) to change configurations, updating software on IoT devices to adjust their behavior, or scaling cloud resources. The action executor ensures that the decisions made by the AFLE are carried out quickly and accurately, adjusting the network in real-time to optimize performance.

The system preferably operates in a continuous feedback loop, with the performance of implemented actions monitored by the network performance monitor. This real-time feedback may be crucial in some applications in order for the learning module to effectively optimize the AFLE's decision-making processes, thereby creating a dynamic system that adapts to changing network conditions and improves its performance over time.

Various hardware and software resources may be used to implement the IoT network management system described herein and its functionalities. The hardware side will typically include suitable servers and computing infrastructure, network devices and sensors, and gateways and edge computing devices.

In particular, high-performance servers may be crucial for processing the vast amounts of data that may be collected by the network performance monitor and for running the adaptive fuzzy logic engine (AFLE) and the learning module. These servers may be on-premises data centers or cloud-based computing services such as, for example, AWS EC2 instances, Google Cloud Compute Engine, or Microsoft Azure VMs, offering scalability and reliability.

Smart routers, switches, and IoT sensors equipped with telemetry capabilities may be required for collecting real-time data on network performance and contextual information. These devices will preferably support advanced monitoring protocols (such as, for example, SNMP and NetFlow) for detailed data collection.

To reduce latency and bandwidth usage, edge computing devices and IoT gateways may be utilized to preprocess data closer to where it is generated before sending it to central servers for analysis. Devices such as Raspberry Pies or industrial IoT gateways equipped with sufficient processing power may be utilized for this purpose.

Software resources which may be utilized to implement the IoT network management system described herein and its functionalities may include fuzzy logic and machine learning libraries, network monitoring and management software, database management systems (DBMS), development frameworks and APIs, security and encryption software, and simulation and modeling tools.

Implementation of the AFLE and the learning module may leverage software libraries and frameworks that specialize in fuzzy logic and machine learning. Possible examples include Scikit-learn and TensorFlow for machine learning, and the Fuzzy Logic Toolbox in MATLAB for designing systems based on fuzzy logic.

For the network performance monitor component, software tools capable of real-time network monitoring and data collection may be necessary. Open-source tools such as Nagios, Zabbix, or commercial solutions such as SolarWinds Network Performance Monitor may be customized to feed data into the AFLE.

To store and manage the collected data, a robust DBMS may be required. Suitable options may include traditional relational databases like PostgreSQL or MySQL for structured data, and NoSQL databases such as MongoDB or Cassandra for unstructured or semi-structured data, depending on the nature of the data.

For developing the action executor and integrating the system components, development frameworks that support API interactions may be utilized. RESTful APIs or MQTT for IoT communications may be used to facilitate actions across the network, and frameworks such as Node.js or Spring Boot may support backend development.

In order to protect data integrity and privacy in the system, suitable security software capable of encryption, anomaly detection, and access control may be necessary. Some embodiments of the system may utilize SSL/TLS for data in transit, and advanced encryption standards (AES) for data at rest, alongside intrusion detection systems (IDS) such as Snort or Suricata.

Before deployment, simulation tools such as OMNeT++ or NS3 may be used to model the network and test the system under various scenarios, thereby helping to ensure that the designed solutions meet the expected outcomes without disrupting the actual network.

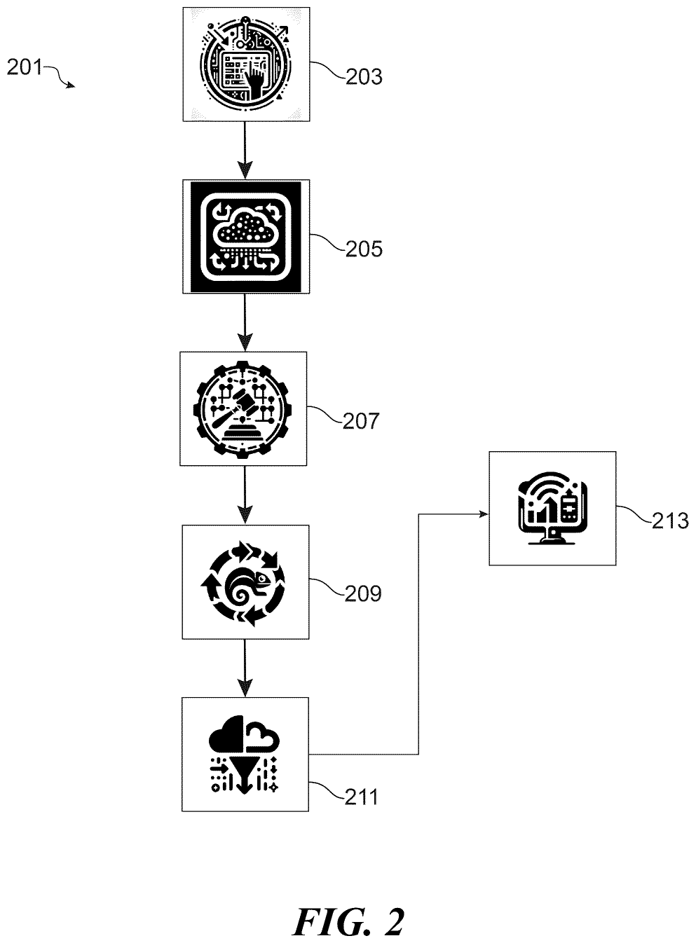

FIG. 2 depicts a particular, nonlimiting embodiment of the AFLE. In the particular embodiment depicted, the AFLE 201 includes an input interface 203, a fuzzification module 205, a rule-based engine 207, an adaptation mechanism 209, a defuzzification module 211, and an output interface 213.

The input interface 203 is responsible for receiving and preprocessing input data from the network performance monitor. It normalizes the input data (such as, for example, bandwidth usage, latency, error rates, device statuses) to be within a range that the fuzzy logic system can process. The input interface ensures that incoming data is in a consistent format and scale for accurate analysis.

The core task of the fuzzification module 205 is to convert the preprocessed, numerical input data into fuzzy values by applying membership functions. These functions map the input values to fuzzy sets like “low,” “medium,” and “high.” Fuzzification allows the AFLE to handle the imprecision and uncertainty inherent in measuring and interpreting network performance metrics.

The rule-based engine 207 is at the heart of the AFLE and contains a set of fuzzy logic rules. These rules define how the system should respond to various combinations of fuzzy input values. For example, a rule might specify that if bandwidth usage is “high” and latency is “low,” then the priority for data routing adjustments should be “medium.” This component uses the fuzzified inputs to evaluate these rules and determine the appropriate actions.

The adaptation mechanism 209 enables the AFLE to learn from the outcomes of its decisions and adapt its membership functions and rules over time. It may employ machine learning algorithms to analyze the effectiveness of past decisions and adjust the parameters of the membership functions or the weights of the rules accordingly, enhancing the system's accuracy and efficiency.

After the rule-based engine determines the fuzzy outputs (decision directives), the defuzzification module 211 converts them back into precise, actionable values or commands that the action executor can implement. This process involves selecting a specific value that best represents the fuzzy output, using techniques such as the centroid method or the mean of maximum.

The final component of the AFLE, the output interface, 213 formats the defuzzified decisions into commands for the action executor. This interface ensures that the decisions are communicated clearly and in a format that the rest of the IoT network management system can act upon, such as adjusting network configurations or rerouting traffic.

Implementing an AFLE with these components allows an IoT network management system to dynamically adjust to changing network conditions, thereby improving or optimizing performance and resource utilization through intelligent, adaptive decision-making based on fuzzy logic.

The general process flow of a preferred embodiment of the AFLE involves the steps of data collection, fuzzification, rule evaluation, adaptation and learning, defuzzification, and action execution. Thus, the process begins with the input interface, which collects real-time data from the network performance monitor. This data includes network performance metrics and contextual information relevant to managing the IoT network.

The collected data is then passed to the fuzzification module. Here, numerical input data is transformed into fuzzy values using membership functions. This step categorizes the inputs into fuzzy sets (like “high,” “medium,” “low”) to handle the vagueness and imprecision typical in real-world data.

These fuzzified inputs are then fed into the Rule-Based Engine, which contains predefined fuzzy logic rules. This engine evaluates the inputs against its rules to determine what actions should be taken. For example, it might decide that if latency is “high” and bandwidth usage is “medium,” then the priority for troubleshooting should be “high.”

Concurrently, the adaptation mechanism observes the effectiveness of the decisions made and the outcomes they produce. It uses machine learning algorithms to analyze past decisions and outcomes, adjusting the membership functions and rules in the Rule-Based Engine to improve decision accuracy and effectiveness over time. This mechanism ensures that the AFLE evolves and becomes more efficient in managing the IoT network.

Once a decision is made, the output from the Rule-Based Engine is still in a fuzzy format. The defuzzification module converts this fuzzy output back into precise, actionable values or commands. This process involves selecting a specific action that best represents the fuzzy decision, making it understandable and executable by the network management system.

Finally, these defuzzified commands are sent through the output interface to the action executor of the IoT network management system. This component implements the decisions, adjusting network configurations, rerouting data, or performing other necessary actions to optimize the network's performance based on the AFLE's directives.

Various hardware and software resources may be utilized to implement the AFLE.

For example, the input interface of the AFLE may use suitable combinations of hardware and software resources to efficiently collect, preprocess, and relay real-time data to the system. On the hardware side, this may include IoT sensors and devices, network infrastructure devices, and edge computing devices. On the software side, this may include data collection and aggregation software, network monitoring tools, middleware and communication protocols, data processing libraries, and APIs for device management and data access.

More particularly, with regard to hardware resources, IoT sensors and devices may be utilized for collecting a wide array of data across the IoT network. Depending on the specific requirements of the network, various sensors (temperature, pressure, humidity, motion, etc.) and smart devices can provide real-time performance metrics and contextual information. Routers, switches, and gateways with advanced telemetry capabilities may be utilized to monitor network traffic, bandwidth usage, latency, and other performance metrics critical for AFLE decision-making. Devices such as Raspberry Pi devices or industrial IoT gateways capable of edge computing may be utilized to preprocess data close to its source, thereby reducing latency and bandwidth requirements for data transmission to central processing units.

With regard to software resources, tools such as Fluentd or Logstash may be utilized to aggregate data from various sources, normalize it, and prepare it for analysis. These tools support a wide range of data formats and sources, making them ideal for heterogeneous IoT environments. Open-source tools such as Prometheus or commercial products such as SolarWinds can monitor network performance metrics in real-time, offering APIs to integrate with custom systems like the AFLE input interface. Middleware solutions, such as MQTT or AMQP, may be utilized to facilitate efficient and reliable data communication between IoT devices and the AFLE. These solutions support various Quality of Service (QOS) levels and are designed to handle the high volume and velocity of data in IoT applications. Software libraries such as Pandas for Python may be utilized to preprocess and clean the collected data, ensuring it is in the correct format and scale for fuzzification. These libraries may be leveraged to handle tasks such as normalization, filling missing values, and converting timestamps. RESTful APIs or specialized IoT platforms such as AWS IoT Core or Microsoft Azure IoT Hub may be employed as standardized methods for accessing and managing data from IoT devices, as well as integrating with other components of the AFLE system.

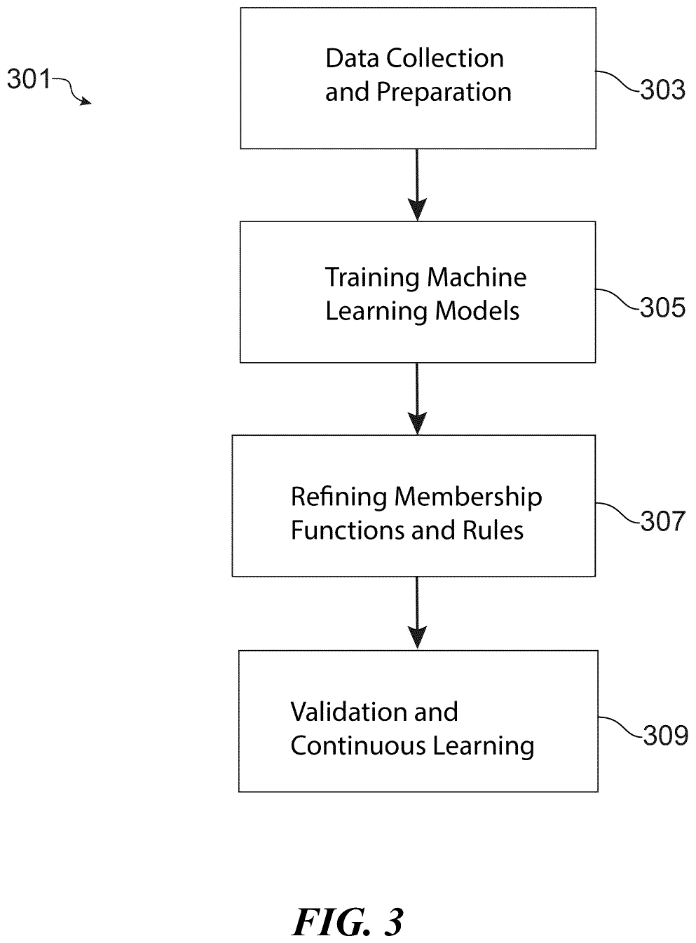

FIG. 3 depicts a particular, nonlimiting embodiment of a method for using machine learning algorithms to refine the membership functions and decision-making rules of the AFLE in an IoT network. The method 301 depicted therein features the steps of data collection and preparation 303, training the machine learning models 305, refining membership functions and rules 307, and validation and continuous learning 309. These steps are described in greater detail below.

In the data collection and preparation 303 step, the system collects data on network performance and the outcomes of previous decisions made by the AFLE. This data includes input variables (such as bandwidth usage, latency, and error rates), the decisions made (for example, rerouting traffic or adjusting device configurations), and the resulting performance metrics. The data is then cleaned and prepared for analysis, which may involve normalization, handling missing values, and feature engineering to better represent the decision-making context.

In the training the machine learning models 305 step, machine learning models are trained on the collected dataset with the goal of predicting the effectiveness of different decision-making rules and membership function parameters under various network conditions. Supervised learning algorithms such as decision trees, support vector machines, or neural networks may be used for this purpose. The target variable for prediction may be a performance metric that reflects the success of a decision, such as reduced latency or increased throughput.

In the refining membership functions and rules 307 step, based on the insights gained from the machine learning models, the system adjusts the membership functions and decision-making rules of the AFLE. For instance, if the model identifies that certain parameters of a membership function consistently lead to better performance outcomes, those parameters can be modified accordingly. Similarly, rules that are found to be less effective can be revised or replaced with more effective ones.

In the validation and continuous learning 309 step, the refined membership functions and rules are validated through simulation or deployment in a controlled environment to assess their impact on network performance. The system continues to collect data on the outcomes of decisions made using the updated functions and rules, feeding this data back into the machine learning models. This creates a feedback loop where the system continually learns and improves over time.

Several considerations may be factored into implementations of the foregoing method. For example, the choice of machine learning model is important and may depend on the complexity of the decision-making context and the availability of data. Deep learning models may offer superior performance in complex scenarios, but typically require more data and computational resources.

Also, proper identification of the most relevant features for predicting decision outcomes may be key to the effectiveness of the machine learning models. Techniques such as feature importance ranking, which involves evaluating the contribution of each feature to the prediction accuracy of a model, may be used for this purpose. Examples of such techniques include, but are not limited to, tree-based methods, coefficients in linear models, wrapper methods, permutation importance, and SHAP (SHapley Additive explanations). Thus, algorithms such as Decision Trees, Random Forests, and Gradient Boosting Machines may be utilized. These algorithms provide a measure of feature importance as part of their operation. They assess how much each feature splits the data to reduce uncertainty or impurity, with more significant splits indicating higher importance.

In linear models (such as linear regression or logistic regression), the coefficients assigned to each feature can indicate their importance. Higher absolute values of coefficients suggest that the feature has a stronger effect on the prediction outcome, assuming all features are standardized.

In wrapper methods, multiple models with different subsets of features and comparing their performance. Techniques such as Recursive Feature Elimination (RFE) systematically remove features to determine their impact on model performance.

Permutation importance involves randomly shuffling the values of each feature and measuring the decrease in the model's accuracy. A significant drop in accuracy indicates a high importance of the feature.

SHAP values are based on game theory and provide a way to understand the contribution of each feature to the prediction for individual observations, as well as on average across the dataset.

Feature importance ranking may have a significant effect in the systems and methodologies disclosed herein. It provides benefits in terms of model simplification, improved performance, interpretability and insights, and resource allocation. Thus, by identifying and removing less important features, models may become simpler, faster, and less prone to overfitting. Focusing on relevant features may also improve the predictive accuracy of models by reducing noise. Understanding which features are most influential in making predictions may provide valuable insights into the underlying processes and aid in interpretability, and knowing which features are important may guide more efficient data collection and processing efforts, focusing resources on what matters most. Implementing feature importance ranking may require careful consideration of the model, the nature of the data, and the specific goals of the analysis. One skilled in the art will appreciate that the importance of a feature may also be context-dependent, varying across different models or problem settings.

It will be appreciated from the foregoing that improving the use and implementation of feature importance ranking in the context of the adaptive management systems for IoT networks described herein may significantly enhance the ability of these systems to adapt and optimize network performance efficiently. Several methods may be utilized for this purpose. These include, but are not limited to, advanced feature selection techniques, dynamic feature ranking, incorporation of contextual importance, the use of feature importance feedback loops, explainable AI integration, cross-layer feature analysis, and customizable importance thresholds. Some of these techniques are described in further detail below.

One approach is to implement more sophisticated feature selection methods to identify the most relevant features for refining membership functions and decision-making rules. Techniques such as Recursive Feature Elimination (RFE) or Minimum Redundancy Maximum Relevance (mRMR) may be leveraged to provide a more nuanced understanding of feature importance relative to the decision-making process of the AFLE.

Another approach is to incorporate a dynamic feature importance ranking mechanism that adjusts in real-time as network conditions change. This approach ensures that the system continuously focuses on the most impactful features under varying scenarios, enhancing its adaptive capabilities.

A further approach is to introduce a mechanism, beyond static feature importance scores, to evaluate the contextual importance of features based on current network conditions, time-of-day, device statuses, or specific events. This may involve weighting feature importance scores by contextual factors, thus allowing the AFLE to prioritize decisions based on real-time relevance.

Another approach is to establish a feedback loop where the outcome of decisions informed by feature importance rankings is analyzed to assess the accuracy of the importance scores. If certain features consistently lead to successful outcomes, their importance scores may be dynamically adjusted upwards, and vice versa. Such a feedback loop may help the system to self-correct and continuously refine its understanding of feature relevance.

A further approach involves the integration of explainable AI (XAI) techniques to provide transparent insights into how feature importance rankings influence decision-making within the AFLE. This approach may enhance trust and understanding among system administrators and stakeholders by clarifying the rationale behind network management decisions.

Yet another approach, given the capability of the system for cross-layer data analysis, is to enhance the feature importance ranking process to consider cross-layer interactions and dependencies. This may involve analyzing feature importance not just within individual layers (such as, for example, the physical and data link layers), but also considering how features across layers interact to impact network performance. This cross-layer analysis may uncover complex interactions that are critical for optimizing network management strategies.

Still another approach is to allow system administrators to set customizable thresholds for feature importance, enabling them to specify which features should be considered significant for decision-making processes. This customization may help tailor the operations of the AFLE to align with specific network management objectives or policies.

As an example of the foregoing, enhancements to the feature importance ranking process to consider cross-layer interactions and dependencies may involve process steps of data aggregation across layers, feature engineering, feature importance analysis, cross-layer dependency mapping, adaptation of AFLE decision making, continuous learning and adjustment, and simulation and testing. These steps are described in greater detail below.

As a first step in the enhancement, data is aggregated and preprocessed from multiple layers of the network. This involves, for example, collecting metrics such as packet loss and latency from the network layer, bandwidth usage from the data link layer, signal strength from the physical layer, and application response times from the application layer. Data normalization may be necessary to ensure consistency across different metrics.

Cross-layer features are then developed that capture interactions between metrics across layers. For example, a feature may represent the interaction between signal strength (physical layer) and packet loss (network layer) to reflect how physical conditions affect network reliability. This step may involve statistical methods, machine learning techniques, or domain expertise to identify meaningful interactions.

Machine learning models are then employees that can quantify feature importance to analyze the engineered cross-layer features. Examples of such models may include, but are not limited to, Random Forests, Gradient Boosting Machines, or other ensemble methods. It is preferred that the choice of model is adapted to provide insights into feature importance based on how they split data points across trees.

Based on the importance scores, dependencies and interactions between layers that significantly impact network performance are mapped out. This may be visualized through a graph or network diagram, highlighting critical paths and dependencies that warrant closer management attention.

The insights from the cross-layer feature importance analysis are then integrated into the AFLE. This may involve adjusting the weights or rules within the fuzzy logic system to prioritize decisions based on the critical cross-layer interactions identified. For example, if an interaction between application response times and network latency is found to be highly impactful, the AFLE may prioritize optimizing network routes to improve latency for critical applications.

A feedback loop is then established where the outcomes of decisions influenced by cross-layer analysis are monitored and analyzed. This feedback may then be utilized to further refine the cross-layer feature importance analysis, ensuring the system continuously adapts to changing network conditions and learns from past decisions.

Of course, prior to full deployment, the modified decision-making process may be simulated in a controlled environment to assess its impact on network performance. This step may help to fine-tune the system, ensuring that the incorporation of cross-layer analysis indeed leads to optimization in network management strategies.

The foregoing process may be utilized by the IoT network management system to leverage cross-layer data analysis to uncover complex interactions that are critical for optimizing network performance. This holistic approach helps to ensure that decisions are made based on a comprehensive understanding of the operational dynamics of the network, leading to more effective and efficient network management.

As a specific example of the foregoing process, consider a smart city IoT network that manages traffic flow and environmental monitoring to illustrate the enhancements in feature importance ranking to consider cross-layer interactions and dependencies. This network utilizes data from various layers: the physical layer (signal strength, noise levels), the data link layer (bandwidth usage, packet errors), the network layer (latency, routing paths), and the application layer (traffic congestion data from cameras, pollution levels from air quality sensors). The objective to be accomplished is to minimize traffic congestion and pollution in urban areas by dynamically adjusting traffic signals and alerting vehicles to optimized routes.

In terms of cross-layer feature engineering, two interactive features are identified that are relevant to the problem. The first is the correlation between signal strength (physical layer) and packet loss (data link layer), indicating areas where communication reliability affects data reporting. The second is the relationship between traffic congestion data (application layer) and network latency (network layer), highlighting how delays in data transmission affect the timeliness of traffic management decisions.

Various software and hardware resources may be utilized to achieve the objective. A Gradient Boosting Machine (GBM) may be utilized to analyze how different features, including the engineered cross-layer features, impact the effectiveness of traffic management strategies. A powerful computing cluster or cloud-based machine learning platform (such as, for example, AWS SageMaker or Google Cloud AI Platform) may be utilized to train and run the GBM model. Suitable IoT data management and analytics software (such as, for example, Apache Kafka for real-time data streaming or TensorFlow or scikit-learn for machine learning) may also be utilized.

Based on the findings of the model, the fuzzy logic rules within the Adaptive Fuzzy Logic Engine (AFLE) may be adjusted to prioritize reducing packet loss in areas critical for traffic data transmission and to respond more rapidly to traffic congestion alerts, even under high network latency conditions. This process may be implemented through the use of network routers and switches capable of dynamic configuration (such as, for example, SDN-capable devices) to adjust routing paths and prioritize traffic, and the use of an IoT platform for centralized network management and decision execution (for example, the IBM Watson IoT Platform or the Microsoft Azure IoT).

A system is then implemented that monitors the outcomes of traffic management decisions (for example, changes in congestion levels or pollution readings) and feeds this data back into the learning module to refine feature importance rankings over time. This may involve, for example, data visualization and monitoring tools (such as, for example, Grafana or Kibana) to analyze the effectiveness of implemented decisions, and the use of a database system capable of handling large-scale IoT data (for example, TimescaleDB or InfluxDB) for storing historical network performance and environmental impact data.

By focusing on these cross-layer interactions and utilizing specific hardware and software resources, the IoT network management system may more effectively optimize traffic flow and reduce environmental impact in urban areas. This demonstrates the practical application and benefits of the enhanced feature importance ranking process.

Various techniques for hyperparameter optimization may be utilized in the systems and methodologies disclosed herein. These techniques may be utilized, for example, to enhance the learning module, optimize AFLE performance, adjust dynamic membership functions, and perform cross-layer optimization. Some of these enhancements are described in greater detail below.

Optimizing the hyperparameters of the machine learning models may significantly impact their performance, especially in the context of the learning module that refines the membership functions and decision-making rules of the AFLE. Hyperparameter optimization in machine learning models is an important process that involves tuning the settings or configurations external to the model that can influence its performance. Unlike model parameters, which are learned from the data during training, hyperparameters are typically set prior to the training process and may have a substantial impact on the efficiency and effectiveness of the learning algorithm.

One beneficial application of hyperparameter optimization is in the learning module, which uses machine learning algorithms to adapt the membership functions and rules of the AFLE. Here, hyperparameter optimization may yield improvements in predictive accuracy and learning efficiency. Techniques such as grid search, random search, Bayesian optimization, or more advanced methods like evolutionary algorithms may be employed to find the optimal settings for the learning algorithms' hyperparameters. This may lead to faster convergence, better adaptation to changing network conditions, and ultimately more effective network management decisions.

Another useful application of hyperparameter optimization is in optimizing AFLE performance. The decision-making process of the AFLE relies on fuzzy logic rules and dynamic membership functions. Hyperparameter optimization may be utilized to fine-tune the parameters that control the shape and adaptability of these functions, ensuring they accurately represent the nuances of the network's operational state. For example, the width and center of a Gaussian membership function may be optimized to better categorize network latency, leading to more nuanced traffic routing decisions.

Another useful application of hyperparameter optimization is in adjustment to dynamic membership functions. Properly tuned hyperparameters may significantly improve model accuracy by ensuring the algorithm is appropriately configured to learn from the data. Hyperparameters may control the complexity of the model. For example, in a decision tree, the depth of the tree is a hyperparameter that may help prevent overfitting (too deep) or underfitting (too shallow). Some hyperparameters influence the training speed and resource consumption. Optimizing these parameters may make the training process faster and more resource efficient.

Incorporating hyperparameter optimization directly into the process of adjusting dynamic membership functions in an AFLE involves a structured approach to systematically fine-tune the parameters that define these functions. Dynamic membership functions are a key component in fuzzy logic systems, allowing for the nuanced interpretation of input variables based on degrees of membership rather than fixed thresholds. By optimizing the parameters of these functions, the system may more accurately represent and respond to the complex and changing conditions of IoT networks.

A particular, nonlimiting process for incorporating hyperparameter optimization directly into the process of adjusting dynamic membership functions in an AFLE involves the steps of defining hyperparameters for membership functions, selecting an objective function for optimization, selecting a hyperparameter optimization technique, integrating the optimization process into the operation of the AFLE, and establishing a feedback loop for continuous learning. These steps are described in greater detail below. By directly incorporating hyperparameter optimization into the adjustment of dynamic membership functions, the AFLE becomes more adaptive and effective in managing IoT networks. This approach enables the system to continuously evolve and respond to the changing dynamics of the network, optimizing performance based on real-time data and outcomes.

The process commences with the identification of adjustable parameters of the membership functions that are critical for, or have a significant impact on, the system's performance. For Gaussian membership functions, for example, these parameters may include the mean (center) and standard deviation (width), which determine the function's shape and spread. For triangular or trapezoidal functions, the parameters might be the positions of the vertices.

Next, an objective function is defined that quantifies the performance of the AFLE in managing the IoT network. This may be based on metrics such as network latency, throughput, energy consumption, or a composite score reflecting multiple aspects of network performance. The objective function serves as the criterion for optimization, guiding the hyperparameter tuning process.

An appropriate hyperparameter optimization technique is then selected that balances efficiency and effectiveness. Some possible choices include, for example, grid search (which exhaustively searches through a predefined set of hyperparameter values but may be computationally intensive), random search (which randomly samples the hyperparameter space, offering a potentially more efficient alternative to grid search with often comparable results), Bayesian optimization (which uses a probabilistic model to guide the search for the best hyperparameters, efficiently finding optimal solutions by learning from previous iterations), and evolutionary algorithms (which mimic natural selection processes to evolve hyperparameters towards optimal solutions over generations).

The optimization process is then directly incorporated into the operation of the AFLE. This may involve periodically triggering the hyperparameter optimization process based on certain criteria, such as after a set number of decisions have been made or when a significant change in network conditions is detected. The AFLE then uses the optimized parameters for its membership functions in subsequent decision-making processes.

Finally, a feedback loop is established where the outcomes of decisions influenced by the optimized membership functions are monitored and analyzed. This feedback is used to further refine the objective function and possibly adjust the hyperparameter space or optimization technique, ensuring continuous improvement of the AFLE's performance.

Implementation of the foregoing approach requires computational resources capable of handling the optimization process in addition to the regular operations of AFLE. Cloud computing services may be leveraged to provide the necessary scalability. Software libraries (such as, for example, Scikit-learn for machine learning, Optuna or Hyperopt for hyperparameter optimization, and TensorFlow or PyTorch for more complex optimization models) may facilitate the implementation of this process.

Another useful application of hyperparameter optimization is in cross-layer optimization, and especially the integration and analysis of cross-layer data. This may involve optimizing hyperparameters related to the weighting of input variables from different network layers or the parameters of algorithms that analyze cross-layer interactions, thereby enhancing the ability of the system to uncover and respond to complex dependencies that affect network performance.

A particular, nonlimiting process for using hyperparameter optimization to improve the integration and analysis of cross-layer data involves the steps of cross-layer data aggregation, feature engineering and selection, defining the objective function, selecting a suitable hyperparameter optimization technique, integrating the optimized model into the network management system, and establishing a feedback mechanism to continuously re-evaluate and re-optimize the hyperparameters of the model. These steps are described in greater detail below. It will be appreciated that, by systematically applying hyperparameter optimization to improve the integration and analysis of cross-layer data, the IoT network management system may achieve a deeper understanding of the operational dynamics of the network, thus leading to more effective decision-making, and optimizing network performance across multiple metrics and layers.

The process commences with the gathering of data from various layers of the network. This may include, for example, physical layer data (such as, for example, signal strength and noise levels), data link layer metrics (such as, for example, throughput and error rates), network layer statistics (such as, for example, latency and packet loss), and application layer information (such as, for example, transaction times, user experiences). The aggregation of this data creates a comprehensive dataset reflecting the multifaceted operational status of the network.

From the aggregated cross-layer data, features are engineered that capture both individual layer metrics and their interactions. This may involve, for example, creating new variables that represent the interdependencies between layers, such as how application layer performance correlates with network layer latency. Given the potentially high dimensionality of the data, feature selection may be critical. Initial models may be utilized to determine the baseline importance of each feature, focusing on those that significantly impact network performance.

The objective function is then defined. This function quantifies the goal of the optimization process, such as minimizing network latency while maximizing throughput. Preferably, this function reflects the balance between different performance metrics that are relevant to the operational goals of the network.

An appropriate hyperparameter optimization technique is then selected to fine-tune the machine learning model used for cross-layer data analysis. Some possible techniques that may be used for this purpose include, but are not limited to, Bayesian optimization (which is efficient for high-dimensional spaces, focusing on exploring parameters that are most likely to improve the objective function), genetic algorithms (which simulate the process of natural selection to explore the hyperparameter space, and are typically good for global optimization), and gradient-based optimization (suitable when hyperparameters are differentiable with respect to the objective function, offering precise adjustments).

The optimized model is then integrated into the network management system, where it is used to analyze cross-layer data and make decisions. This may involve adjusting routing protocols based on detected inter-layer dependencies or reallocating resources to address predicted bottlenecks.

Finally, a feedback mechanism is established that monitors the outcomes of decisions based on the model's analysis. This feedback mechanism is used to continuously re-evaluate and re-optimize the hyperparameters of the model, thereby ensuring that the system remains adaptive to changing network conditions and operational requirements.

The implementation of the foregoing optimization process typically requires computational resources that are capable of handling complex models and large datasets. Cloud computing platforms may be leveraged for this purpose to provide the necessary scalability and flexibility. Suitable software libraries such as TensorFlow (for building machine learning models), Optuna or Hyperopt (for hyperparameter optimization), and Pandas or Apache Spark (for data processing and feature engineering) may be utilized for this process.

Various techniques may be utilized for hyperparameter optimization in the systems and methodologies disclosed herein. These include, without limitation, techniques such as grid search, random search, Bayesian optimization, gradient-based optimization, and evolutionary algorithms. Grid search is a brute-force approach that evaluates model performance for a comprehensive combination of hyperparameters. While thorough, it can be computationally expensive. Random search evaluates a random selection of hyperparameter combinations. It is more efficient than grid search, especially when some hyperparameters are more influential than others. Bayesian optimization uses a probabilistic model to guide the search for the best hyperparameters, focusing on combinations that are more likely to yield improvements. Gradient-based optimization is applicable when hyperparameters can be differentiated; it adjusts hyperparameters in the direction that reduces validation error. Evolutionary algorithms mimic natural selection processes to iteratively select and refine hyperparameters based on their performance.

The foregoing applications of hyperparameter optimization typically require computational resources for processing and analysis, particularly if employing computationally intensive methods such as Bayesian optimization or evolutionary algorithms. Cloud computing platforms with scalable processing capabilities and machine learning frameworks that support hyperparameter optimization (such as, for example, Scikit-learn or TensorFlow) may be utilized for this purpose. Additionally, specialized software tools for hyperparameter optimization, such as Hyperopt or Optuna, may be leveraged to further streamline the process.

Dynamic membership functions are an important component of some embodiments of the systems and methodologies disclosed herein which feature adaptive fuzzy logic systems. These functions offer a flexible approach to handle the variability and uncertainty inherent in real-world applications. Unlike static membership functions, which have fixed shapes and parameters, dynamic membership functions may adjust their characteristics in response to changing conditions or new information. This adaptability enhances the capability of fuzzy logic systems to model complex, non-linear systems more accurately over time. Dynamic membership functions may enable more nuanced and flexible modeling of complex, uncertain environments.

Membership functions may have various characteristics and components, of which shape and parameters are often key aspects. Common shapes for membership functions include triangular, trapezoidal, Gaussian, and bell-shaped curves. Dynamic membership functions may alter these shapes to better represent the data as the system learns or as conditions change. Common parameters may include aspects such as the center, width, and slope of the membership functions. In dynamic systems, these parameters may be adjusted based on learning algorithms or optimization techniques to refine the fuzzy logic system's performance.

In some embodiments of the systems and methodologies disclosed herein, machine learning algorithms may be used to adjust the parameters of membership functions based on performance feedback. Algorithms such as gradient descent, evolutionary algorithms, or reinforcement learning may be utilized for this adaptation process.

In some embodiments of the systems and methodologies disclosed herein, dynamic membership functions may adjust in real-time based on incoming data streams. Such real-time adjustments may be particularly useful in IoT applications, where sensor data may vary significantly over time or across different environmental conditions.

Various considerations may be taken into account in the implementation of dynamic membership functions in the systems and methodologies disclosed herein. Typically, initial shapes and parameters will need to be defined, possibly based on expert knowledge or preliminary analysis. The system then refines these settings over time.

The system will typically require clear criterion for optimization, such as minimizing error, maximizing accuracy, or balancing precision and recall. These criteria guide the adaptation of membership functions.

It will be appreciated that adapting membership functions in real-time or through complex learning algorithms may increase computational demands. Efficient algorithms and hardware acceleration techniques may be utilized to mitigate these challenges.

The use of dynamic membership functions offers many advantages in the systems and methodologies disclosed herein. For example, by continuously refining their parameters, dynamic membership functions can maintain or improve the accuracy of the fuzzy logic system under changing conditions. Dynamic membership functions also offer the ability to model complex, dynamic systems across various domains, from control systems to decision-making and prediction in uncertain environments. Systems equipped with dynamic membership functions may quickly respond to changes, making them suitable for applications requiring real-time adjustments, such as adaptive control systems or real-time monitoring and analysis.

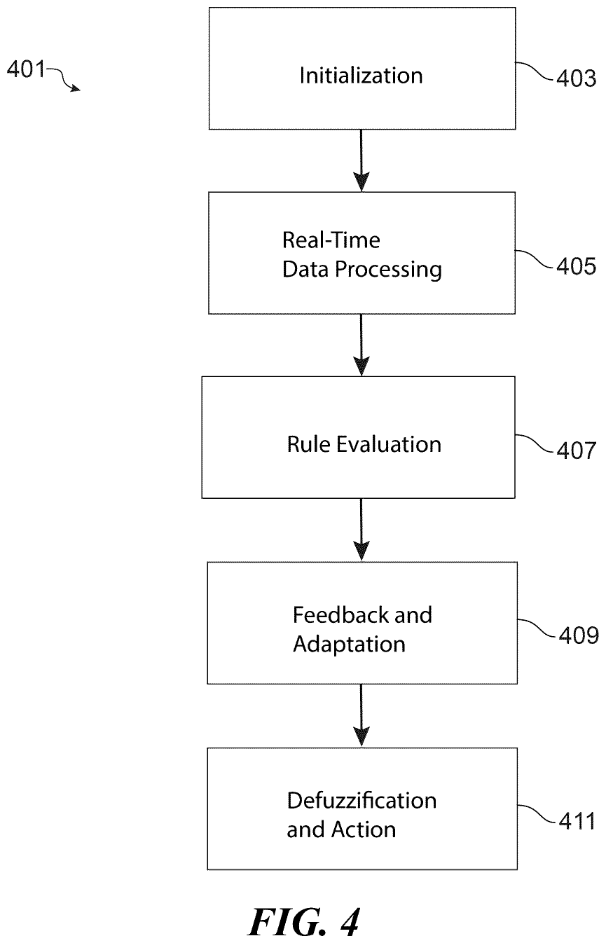

FIG. 4 depicts a particular, nonlimiting embodiment of a method for using machine learning algorithms to refine the membership functions and decision-making rules of the AFLE in an IoT network. The method 401 depicted therein features the steps of initialization 403, real-time data processing 405, rule evaluation 407, feedback and adaptation 409, and defuzzification and action 411. These steps are described in greater detail below.

The AFLE initializes 403 with predefined membership functions for each input variable, based on expert knowledge or initial analysis. These functions categorize the inputs into fuzzy sets, such as “low,” “medium,” and “high.”

As real-time data flows in, the AFLE uses the current membership functions to fuzzify the inputs. This real-time data processing 405 converts numerical values into fuzzy values based on the degree of membership to each fuzzy set.

The AFLE applies its fuzzy logic rules 407 to the fuzzified inputs to determine actions. These rules are formulated based on expert knowledge or learning algorithms and specify the system's response under various conditions.

The system evaluates the effectiveness of the decisions made and uses feedback mechanisms 409, such as machine learning algorithms, to adjust the parameters of the membership functions. This could involve shifting the center of a Gaussian curve or changing the width of a trapezoidal function to better capture the characteristics of the data.

For example, suppose that network congestion is frequently underestimated, leading to delayed actions. A machine learning model, such as a gradient boosting machines (GBM), analyze historical data to find that adjustments to the “high congestion” membership function (e.g., expanding its range) correlate with more timely and effective traffic rerouting decisions. The system then automatically adjusts the parameters of this membership function accordingly, leading to improved traffic management.

The output of the rule evaluation, still in fuzzy form, is then defuzzified 411 into a precise action or value, which is implemented by the action executor.

The following particular, nonlimiting example illustrates the foregoing process. Consider an IoT network where the AFLE is tasked with managing network traffic to avoid congestion. As inputs, the system receives real-time data on bandwidth usage and packet delay from network devices. In the initial membership functions, bandwidth usage may have three sets (low, medium, high) defined by triangular membership functions, and packet delay may be categorized similarly. Based on fuzzy logic rules, if bandwidth usage is “high” and packet delay is “medium,” the decision might be to reroute some traffic.

Suppose after implementing several decisions, it is observed that the “high” bandwidth usage often does not lead to congestion as previously thought due to the network's adaptive capabilities. The system then adjusts the membership function for “high” bandwidth usage to reflect a higher threshold. With the adjusted membership functions, the system may now decide that even with what was previously considered “high” bandwidth usage, no rerouting is necessary, optimizing network efficiency without unnecessary adjustments. This example illustrates how the use of dynamic membership functions by AFLE allows it to adapt to the evolving characteristics of the network, enhancing decision accuracy and network performance over time.

Some embodiments of the systems and methodologies disclosed herein may make advantageous use of cross-layer optimization techniques. The use of these techniques involves a holistic approach to network management that considers multiple layers of the network architecture simultaneously. This approach contrasts with traditional network management strategies that operate within the confines of individual layers independently. The layers implicated in this approach typically include the physical layer, data link layer, network layer, transport layer, and application layer.

Systems and methodologies of the type disclosed herein may be adapted for cross-layer optimization techniques through suitable modifications to network data collection, AFLE, the learning module, and the action executor.

For example, the system may integrate data collected by the network performance monitor from various layers, such as physical layer signal strength, data link layer throughput, network layer congestion information, transport layer session states, and application layer user demands. By analyzing this integrated data, the system may identify correlations and causations that might not be evident when looking at a single layer in isolation.

The AFLE may utilize dynamic membership functions that are sensitive to cross-layer interactions. For example, a membership function may categorize network congestion not just on network layer metrics (such as packet loss or delay) but may also include application layer impacts (such as, for example, video streaming quality) and physical layer conditions (such as, for example, interference levels).

The AFLE may also utilize dynamic membership functions sensitive to cross-layer interactions for dynamic traffic management. For example, when the network experiences variable data traffic, the AFLE may adjust membership functions to prioritize traffic dynamically. For instance, if the application layer reports high demand for video streaming services while the physical layer experiences increased noise levels, the AFLE may adjust its membership functions to categorize network conditions as “critical.” This would trigger prioritization of bandwidth for streaming services, possibly by reducing bandwidth allocation for less critical services or by suggesting adaptive bitrate streaming to maintain service quality.

The AFLE may also utilize dynamic membership functions sensitive to cross-layer interactions for energy efficient IoT device management. For example, for IoT networks focused on energy conservation, such as in smart city or smart home environments, the AFLE may use dynamic membership functions that account for device energy status (application layer) and signal strength (physical layer). If a device reports low battery but is critical for monitoring environmental conditions, the AFLE may adjust its membership functions to classify this scenario as “high priority for energy conservation.” Consequently, the system might decide to reduce the frequency of data transmission for less critical devices or suggest a routing path that requires less power consumption.

The AFLE may also utilize dynamic membership functions sensitive to cross-layer interactions for adaptive security postures. For example, the AFLE may employ dynamic membership functions to adjust security measures based on threat levels detected at different layers. For example, if an anomaly is detected at the network layer (unusual data packets) and correlated with unauthorized device attempts at the application layer, the AFLE may dynamically adapt its security posture, prioritizing these incidents as “high security threat.” The system may then implement stricter authentication measures or isolate affected network segments to mitigate potential breaches.

The AFLE may also utilize dynamic membership functions sensitive to cross-layer interactions for optimized resource allocation for multitier applications. In complex IoT environments running multitier applications, the AFLE may optimize resource allocation by understanding cross-layer dependencies. For example, if an application layer requires high computation resources for data analytics tasks and the data link layer shows bandwidth saturation, the AFLE's dynamic membership functions may facilitate the decision to offload some computational tasks to the cloud or edge computing resources, thereby ensuring optimal performance without overloading the network bandwidth.

The learning module may employ machine learning algorithms to learn optimal network management strategies that consider the interdependencies between layers. For instance, it may learn that adjusting the data rate at the physical layer could alleviate congestion at the network layer more efficiently than simply rerouting traffic.

Actions executed to optimize network performance may span multiple layers. For example, in response to detected congestion affecting a video streaming application, the system may simultaneously adjust QoS settings at the network layer and suggest bitrate changes at the application layer to maintain video quality.

The following specific, nonlimiting example illustrates the aforementioned advantages of cross-layer optimization techniques to an IoT network.

Consider an IoT network where video surveillance data is transmitted from cameras to a centralized monitoring system. The network experiences varying levels of congestion, impacting video quality. The system collects data on packet loss (network layer), available bandwidth (data link layer), and video frame rate (application layer).

Based on cross-layer data, the AFLE determines that congestion is causing video degradation. It identifies that the root cause is not just network traffic but also interference at the physical layer affecting bandwidth.

The learning module analyzes historical data and identifies that reducing transmission power in certain devices to minimize interference (physical layer), combined with adjusting the routing protocol to bypass congested nodes (network layer), has previously led to improved video quality.

The action executor implements the recommended adjustments. It reduces the transmission power of specific devices and updates the routing protocol. Additionally, it sends a suggestion to the video application to slightly reduce the bitrate to accommodate the current network conditions.

It will be appreciated from the foregoing that, by applying cross-layer optimization techniques, embodiments of the systems disclosed herein may manage the IoT network more effectively, ensuring improved or optimal performance across all layers of the network architecture. This holistic approach enables the system to adapt to complex, dynamic conditions in real-time, improving network efficiency and the quality of service for end-users.

Some embodiments of the systems and methodologies disclosed herein may make advantageous use of Particle Swarm Optimization (PSO). PSO, a computational method that optimizes a problem by iteratively trying to improve a candidate solution with regard to a given measure of quality, may be utilized to improve several aspects of these systems and methodologies.

For example, PSO may be used to optimize the parameters of the dynamic membership functions within the AFLE. By iteratively adjusting these parameters, PSO may help find the optimal shape and position of the membership functions to accurately represent the current network conditions and make more effective decisions.

PSO may also be utilized for learning module optimization. The learning module aims to continuously refine the decision-making process based on the outcomes of past decisions. PSO may be applied here to fine-tune the learning algorithms or the decision-making rules themselves, thereby optimizing the ability of the system to learn from its actions and improve network performance over time.

PSO may also be leveraged for network configuration adjustments. In implementing decisions made by the AFLE, the system may face complex optimization problems, such as determining the optimal routing of data packets, bandwidth allocation, or the prioritization of devices. PSO may provide a means for exploring various configurations and selecting the one that best meets the current needs and performance goals of the network.

PSO may also be utilized in cross-layer optimization techniques. Here, PSO may be instrumental in optimizing decisions that affect multiple layers of the network stack. By evaluating the impact of various decisions across layers, PSO may help identify configurations that offer the best overall performance improvement. Utilizing PSO in cross-layer optimization for an IoT network management system typically involves coordinating decisions that impact multiple layers of the network architecture to improve overall performance.

As an example of how PSO may be applied to cross-layer optimization for an IoT network management system, consider an IoT network in a smart city application, where sensors collect data on environmental conditions, traffic, and utility usage. The network's performance is critical for timely data collection and analysis but must be balanced against energy consumption, especially for battery-powered sensors. The goal is to optimize network energy efficiency while ensuring sufficient data throughput to meet application requirements.

Several cross-layer considerations apply to the problem. In the physical layer, transmission power levels of IoT devices can be adjusted to save energy but may affect signal strength and data rates. In the data link layer, duty cycles for IoT devices can be optimized to reduce energy consumption, affecting data transmission intervals. In the network layer, routing protocols can be adapted to create energy-efficient paths for data transmission, impacting latency and throughput. In the application layer, data sampling rates may be adjusted based on the criticality of the information, influencing energy usage and the volume of data transmitted.

The application of PSO here is an iterative process in which a swarm of particles is first initialized, each representing a potential solution encoding parameters across the layers, such as transmission power levels, duty cycles, routing choices, and data sampling rates.

The objective function is integral to PSO. It is a mathematical representation of the problem to be solved or the goal to be achieved with the optimization process, and it quantitatively expresses how well a given solution (represented by a “particle” in the swarm) meets the desired outcome. The objective function evaluates the trade-off between energy efficiency and data throughput. It may combine metrics such as total energy consumed by the network and the average data throughput or latency experienced.

Each particle adjusts its position (that is, the set of parameters it represents) based on its own best position, the overall best position of the swarm, and a set of velocity rules. The adjustments aim to explore the solution space to find an optimal balance between energy efficiency and throughput. Here, it is noted that velocity rules determine how particles in the swarm move through the solution space in search of the optimal solution. These rules are mathematical formulas that update each particle's velocity based on its past movements, the success of its neighbors, and the best solutions found so far. The velocity of a particle dictates how its position (representing a potential solution) changes from one iteration to the next

After each iteration, the particles' positions are evaluated using the objective function. This typically involves simulating or calculating the network's performance based on the cross-layer parameters each particle represents.

The process continues until a termination criterion is met. The termination criterion may be, for example, a maximum number of iterations or a threshold improvement in the objective function. The best solution found by the swarm represents the optimal set of cross-layer parameters to achieve the desired balance between energy efficiency and throughput.

Various additions and modifications to the systems and methodologies disclosed herein are possible without departing from the scope of the present disclosure. Some of these are described below.

Some embodiments of the systems and methodologies disclosed herein may utilize the integration of machine learning algorithms for predictive analytics. Beyond using fuzzy logic for decision-making, the integration of machine learning algorithms may enhance the ability of the system to predict network conditions and adapt strategies proactively. Techniques such as reinforcement learning may enable the system to learn optimal decision-making policies based on historical data and network conditions, improving over time.

Some embodiments of the systems and methodologies disclosed herein may implement cross-layer optimization techniques that consider not only the network layer but also the physical, MAC, and application layers. This approach may provide a more holistic approach to network management. Such embodiments may include adaptive data aggregation strategies to minimize energy consumption and optimize data transmission based on application-specific requirements.

Some embodiments of the systems and methodologies disclosed herein may integrating advanced security features that leverage the adaptive capabilities of the system to detect and mitigate security threats in real-time. Such embodiments may involve adaptive encryption techniques or anomaly detection systems that adjust based on detected threat levels.

Various input variables that may be used in the data collection and preparation step of the AFLE, and data on these variables may be collected by the network performance monitor. Such variables may include, for example, bandwidth usage, latency, error rates, device connectivity status (for example, online, offline, intermittent), energy consumption of IoT devices or network infrastructure, environmental conditions (for example, temperature, humidity, or weather conditions that may impact device performance and network reliability), traffic patterns (including, for example, peak usage times and data flow directions), device type and capabilities (for example, the variety and capabilities of devices on the network, such as sensors, actuators, or smart devices), security threats and anomalies quality of service (QOS) metrics (such as, for example, packet loss rate, jitter, and throughput for different services or applications running on the network), signal strength, network topology changes, user demand and application requirements, or feedback from end-users.

Real-time data on various types of contextual information may be collected by the network performance monitor. These include, without limitation, time of day, geolocation data, network topology changes, device types and capabilities, application types, user demand, environmental conditions, security threats and anomalies, energy consumption patterns, and regulatory and policy constraints (such as, for example, data sovereignty laws or industry-specific regulations).

Various decisions may be made by the AFLE, and the effectiveness of past decisions of this type may be considered by the AFLE. These include, for example, rerouting traffic, adjusting device configurations, resource allocation, priority settings, device configuration updates, security measures activation, energy saving actions, dynamic sleep scheduling, adaptive data sampling rates (for example, adjusting the frequency at which IoT devices sample and report data based on current needs and network conditions, to balance between timely data reporting and network resource conservation), error correction level adjustment (for example, dynamically adjusting the error correction settings of data transmission protocols to maintain data integrity under varying network conditions, such as increased interference or congestion), network scalability actions, (for example, making decisions on when and how to scale the network infrastructure, either up or down, based on real-time and predicted future demands, to help ensure that the network can efficiently handle varying loads), quality of service adjustments (for example, modifying QoS parameters for different applications or services running on the IoT network to ensure critical applications have the necessary bandwidth and latency guarantees), load balancing among servers/nodes, or disaster recovery and failover procedures.

In some embodiments, the adaptive fuzzy logic engine (AFLE) may be configured to correlate performance data from multiple layers of the network stack, including at least the physical layer, data link layer, network layer, and application layer. By integrating data across these layers, the AFLE can more accurately represent the complex interactions that influence overall network performance, such as how signal-level interference at the physical layer affects achievable throughput at the data link layer, or how routing adjustments at the network layer impact application-level responsiveness. The AFLE may maintain distinct membership functions or fuzzy sets for metrics originating in each layer and then combine these memberships within its inference process to arrive at a more comprehensive view of network conditions.

In this cross-layer correlation approach, the AFLE dynamically adjusts membership functions in response to correlations observed among the collected metrics. For example, if the system detects that a particular quality-of-service parameter in the application layer tends to degrade whenever physical-layer interference exceeds a defined threshold, the AFLE may refine its membership functions to increase the priority of mitigating that interference during future decision cycles. Likewise, when network-layer routing changes prove ineffective under certain high-interference conditions, the AFLE may learn to trigger physical-layer power adjustments, channel reassignments, or other remedial actions in tandem with routing updates. By integrating data from all relevant layers in a unified fuzzy logic framework, the system is able to adapt more holistically and precisely to evolving network conditions, thereby improving performance metrics such as latency, throughput, and overall reliability.

In one exemplary implementation of the foregoing embodiment, the disclosed innovation is deployed in a multi-tier IoT network architecture that manages performance and security in real time. The network may comprise numerous IoT devices (such as sensors and actuators), at least one local gateway node, and a remote or cloud-based analytics layer. Each gateway node possesses sufficient computational capability (such as, for example, a small-form-factor server, industrial edge platform, or similar hardware) to host an instance of the adaptive fuzzy logic engine (AFLE). This AFLE receives raw network data and contextual metrics from the gateway's attached IoT devices.

A distinguishing feature of this embodiment is that the AFLE maintains layer-specific membership function subsets to handle data originating from the physical, network, and application layers. At the physical layer, for example, membership functions may classify signal-to-noise ratios or channel interference, while at the network layer, the engine may categorize congestion levels or packet loss rates. Within the application layer, fuzzy sets can reflect service-level performance, such as latency thresholds or user-perceived responsiveness. The AFLE further employs a weighted aggregation scheme that combines these layer-specific outputs into a unified inference process; if the physical layer metrics suggest critical interference, those metrics can receive a higher weight, whereas the application layer may dominate if quality of service data reveals severe user-impacting issues.

To refine these membership functions over time, the gateway node's learning module implements a hyperparameter optimization routine (possibly employing evolutionary algorithms, Bayesian optimization, or other metaheuristic methods) to fine-tune parameters such as the centers and widths of the fuzzy sets. This allows the AFLE to converge on more accurate decision boundaries, particularly as the system collects real-world feedback on how membership function updates affect network performance. In addition, triggered or on-demand adaptations ensure that critical events (such as, for example, severe packet loss, unexpected topology changes, or high-severity security anomalies) immediately prompt recalculation of relevant membership functions to avert further degradation.

For large-scale deployments, a multi-tier orchestration mechanism coordinates decision-making between the local gateway and a cloud-based analytics layer. The gateway node focuses on immediate, low-latency reconfigurations (for example, adjusting transmission power or scheduling device wake cycles), while the cloud collects historical logs and applies more computationally intensive analytics to recognize long-term trends or system-wide anomalies. If cloud analytics detect a pending surge in demand across multiple regions, for example, they can instruct each gateway to preemptively shift membership functions toward handling higher traffic, thereby mitigating congestion before it occurs. This integrated design leverages powerful cloud resources for macro-optimization without sacrificing the gateway's capacity for near-instant local control.

In sum, this embodiment establishes a layer-aware, dynamically optimized fuzzy logic engine with the ability to respond to network conditions in both proactive and reactive modes. The specialized membership function subsets help capture each layer's unique metrics, while the learning module's hyperparameter optimization ensures the AFLE continuously evolves based on measured outcomes. Trigger-based adaptation further enhances responsiveness by recalculating membership functions whenever threshold events demand urgent adjustments, and the multi-tier coordination promotes overall scalability and consistency across a geographically distributed IoT environment.

In some embodiments, the learning module may include a hyperparameter optimization component that systematically refines the shape parameters of the adaptive fuzzy logic engine's (AFLE) dynamic membership functions. Such shape parameters may include the center values (or means) of membership functions, the widths (or spreads) that control the transition between fuzzy sets, or the overall shapes of the membership curves (for example, Gaussian versus trapezoidal). Unlike ad hoc or heuristic modifications of membership functions, these hyperparameter adjustments are guided by an iterative optimization process-potentially employing algorithms such as grid search, Bayesian optimization, or particle swarm optimization (PSO)—to explore a range of possible configurations.

Feedback collected from each decision cycle in the IoT network informs the optimization loop. For instance, if a particular combination of membership function centers and widths reduces overall network latency or improves energy efficiency, the hyperparameter optimization component adjusts future membership function settings accordingly. Conversely, if performance metrics degrade, the system alters the membership function parameters to correct for observed deficiencies. By continuously evaluating and updating these hyperparameters, the AFLE can converge on membership function configurations that respond more precisely to real-time network behaviors and constraints, resulting in greater decision accuracy and more effective IoT network management.

In certain embodiments, this hyperparameter optimization component may work in concert with a fuzzy logic framework capable of dynamically refreshing membership function definitions on demand. The component may employ one or more open-source or commercial libraries that support iterative search methods, such as evolutionary algorithms, Bayesian inference-based strategies, or reinforcement-learning-driven optimization. At each decision cycle, the AFLE updates network settings (for example, by rerouting traffic or adjusting device transmit power) and the observed performance metrics are collected as feedback. If improvements are detected (e.g., lower latency, higher throughput, or reduced energy consumption), the hyperparameter optimization component refines its parameter candidates in future iterations. Conversely, if adverse effects appear, the optimization module discards or modifies the current membership function settings, thus continually seeking more suitable configurations.

Because the optimization process may iterate frequently, each gateway node or local computing unit in the IoT environment is preferably provisioned with sufficient computational resources-such as a multi-core CPU, GPU, or a dedicated accelerator—to run the chosen search algorithms without hindering normal network operations. Larger or more complex networks may delegate more computationally intensive tasks to a central analytics platform, while each gateway node applies the final membership function updates locally to ensure low-latency adaptation. In this manner, the system achieves a data-driven, incremental approach that steadily hones membership function shapes, boundaries, or curve types based on performance outcomes observed under real-world conditions. By integrating both iterative feedback and on-the-fly recalibration of fuzzy sets, the AFLE ultimately makes more accurate and context-aware decisions in managing IoT devices and traffic.

In some embodiments, the learning module employs a multi-objective metaheuristic algorithm to optimize both the membership functions and the fuzzy rules of the adaptive fuzzy logic engine (AFLE). Unlike single-objective approaches, which aim to improve only one performance metric (for example, latency or packet loss), multi-objective metaheuristics are designed to seek Pareto-optimal solutions across multiple, and potentially competing, objectives. By way of example, the learning module may simultaneously assess both average network latency and overall throughput—or, in some implementations, trade off energy efficiency versus response time. The algorithm, which may be selected from well-known methods such as particle swarm optimization (PSO), genetic algorithms (GA), or simulated annealing, iterates over a population of candidate solutions; each candidate reflects a different set of membership function parameters or fuzzy rules that influence how the AFLE responds to changing network conditions.

Through repeated evaluation and feedback, the multi-objective metaheuristic converges on configurations that represent acceptable compromises among the targeted metrics. For instance, if one solution sharply reduces latency but causes excessive energy consumption, the algorithm may identify an alternative configuration that achieves a more balanced outcome. In this way, the learning module ensures that the AFLE maintains a nuanced grasp of network objectives, preventing the optimization of any single metric from unduly degrading other critical aspects of performance. By adopting a multi-objective metaheuristic approach, the system can better accommodate the diverse demands typically encountered in complex IoT environments, demonstrating an enhanced adaptive capability that extends beyond conventional single-objective fuzzy control methods.

In one illustrative embodiment, the learning module begins by creating an initial population of candidate configurations, where each candidate specifies a distinct combination of fuzzy membership functions and rules. For example, one candidate may weight “low latency” behavior more heavily, whereas another focuses on achieving minimum energy usage across connected devices. To evaluate each candidate, the system deploys it within the AFLE for a specified test interval, measuring relevant metrics-such as average latency, throughput, and energy consumption-over that period. The multi-objective metaheuristic then identifies which candidates perform well across multiple goals and which over-optimize one metric at the expense of others. Candidates demonstrating unbalanced performance (for instance, drastically lowering latency but severely increasing power draw) are mutated, recombined, or discarded, while those achieving more balanced results are refined over successive iterations.

Depending on implementation details, particle swarm optimization, genetic algorithms, or simulated annealing may be used to evolve the population of solutions. These methods systematically explore the search space by combining or altering promising solutions in pursuit of Pareto-optimal outcomes—i.e., sets of solutions representing the best achievable trade-offs among competing objectives. Once the metaheuristic converges on one or more Pareto-optimal configurations, the learning module may select a single global best candidate or dynamically switch among multiple optimal solutions depending on real-time conditions and policy preferences.

From a hardware standpoint, each gateway node or edge server in the IoT network should have sufficient processing capacity—such as a multi-core CPU or GPU acceleration—to handle population-based metaheuristic searches. On the software side, the learning module may utilize open-source libraries supporting multi-objective functions (e.g., NSGA-II for genetic algorithms or a multi-objective variant of PSO), along with an objective metric interface that consolidates measurements of latency, throughput, energy usage, or application-specific parameters. The fuzzy logic framework must also permit hot-swapping of membership function configurations to accommodate iterative testing of candidate solutions. By integrating these resources into a cohesive multi-objective search, the system ensures that improvements in one performance metric do not inadvertently degrade another, ultimately yielding a holistic, adaptive approach to IoT network management.

In some embodiments, the adaptive fuzzy logic engine (AFLE) leverages a feature importance-driven approach when adjusting membership functions in real time. Rather than treating all input variables as equally significant, the learning module computes a dynamic importance ranking that reflects the observed influence of each variable on key performance metrics—for example, device battery levels, buffer occupancy, or packet loss rates. These importance scores may be derived through tree-based ranking methods, permutation tests, or other feature selection algorithms that quantify each variable's impact on network outcomes. The learning module then provides this feature importance ranking to the AFLE, which uses it to weight membership function updates accordingly. High-ranked inputs receive more granular or aggressive adjustments, while lower-ranked inputs are deprioritized or remain relatively unchanged.

From a hardware standpoint, implementing the feature importance calculations in near-real time generally requires that each local gateway node or edge computing device host both the learning module and the AFLE. A multi-core processor or GPU acceleration can be advantageous, particularly when large volumes of streaming data must be analyzed (for instance, data from numerous sensors or devices). On the software side, the system may employ standard machine learning libraries—such as scikit-learn, XGBoost, or similar frameworks—that support feature ranking. The AFLE itself typically relies on a modular fuzzy logic library that permits dynamic adjustments to membership function parameters based on weighting factors. By updating membership functions in proportion to the variable's importance ranking, the fuzzy logic engine becomes better aligned with real-time network priorities, devoting finer control to those variables that most heavily influence latency, throughput, or other network objectives.

Furthermore, the system is configured to automatically recalibrate the importance ranking upon detecting abnormal or unexpected network conditions. For instance, if a sudden surge in packet loss is observed, metrics related to congestion or malicious traffic patterns may be immediately designated as more significant. This triggers the AFLE to prioritize reconfigurations aimed at mitigating the identified threat—such as rerouting traffic flows or adjusting transmit power levels—thus ensuring that membership function updates focus on the most pressing variables. These recalibrations may occur at predefined intervals or as soon as anomalies surpass certain thresholds, enabling the AFLE to respond swiftly to fast-changing circumstances. By continuously aligning membership function adaptations with real-time feature importance scores, the system becomes more context-aware and more effectively handles volatile network scenarios, a capability not typically found in conventional fuzzy logic controls that rely on static or uniform weighting of input variables.

In certain embodiments, the action executor operates within a hierarchical or distributed control architecture, rather than relying on a single, centralized controller to implement all reconfiguration decisions. Under this arrangement, a top-level management entity may establish high-level optimization goals for the network-such as balancing load, minimizing latency, or improving energy efficiency—while multiple local gateway nodes (or sub-executors) handle the actual, real-time execution of changes. Each sub-executor is assigned responsibility for a discrete subset of devices or a specified region, and it applies localized outputs from the adaptive fuzzy logic engine (AFLE) to enact adjustments (for example, changing routing paths or adjusting device transmit power). This design allows each gateway node to promptly respond to immediate circumstances, such as local congestion or device faults.

From a hardware perspective, the sub-executors may be implemented on robust edge computing devices or small-form-factor servers equipped with sufficient CPU and memory resources to handle the AFLE's inference tasks and local telemetry processing. In larger IoT or

Web3 deployments, additional sub-executors can be introduced seamlessly, making it straightforward to scale the system as the network expands. On the software side, each sub-executor typically runs a lightweight suite that includes the fuzzy logic framework (for example, a C++ or Python-based fuzzy inference engine) plus a communications module to exchange current network states and commands with the higher-level management entity. Messaging protocols such as MQTT or gRPC may be used for secure, low-latency data transfer.

By distributing the execution process across multiple sub-executors, the round-trip latency inherent in forwarding all updates to a central controller is significantly reduced. For instance, if a localized subset of IoT devices undergoes a drop in link quality or experiences a surge in traffic, the responsible sub-executor can immediately enact partial reconfiguration—for example, allocating additional bandwidth or adjusting device wake-sleep schedules—without relying on a network-wide orchestration phase. This tiered approach not only ensures swift responses to regional issues but also improves fault tolerance, as neighboring sub-executors can continue providing localized control if one gateway node fails. Consequently, the system sustains normal operations even when isolated segments of the network encounter disruptions, thus offering enhanced resilience and scalability relative to a single-controller design.

In certain embodiments, the adaptive fuzzy logic engine (AFLE) extends its monitoring capabilities to encompass security indicators spanning multiple network layers, thereby enabling real-time security adaptation. By way of example, at the network layer, metrics such as anomalous spikes in traffic volume, suspicious packet signatures, or repeated access failures may be collected, whereas application-layer inputs can include unusual API requests, malformed data payloads, or error logs indicative of malicious activity. By aggregating and correlating these heterogeneous indicators, the AFLE can detect correlated anomalies that may signal an emerging security threat—for instance, a denial-of-service attempt or the stealthy spread of malware across multiple devices.

From a hardware standpoint, each IoT gateway or edge node is provisioned with sufficient computational resources—such as a multi-core CPU or a modest GPU—to run both the AFLE's fuzzy inference routines and the necessary security data-processing modules (or intrusion detection system, if employed). Software components typically include modules capable of parsing network traffic headers, analyzing application-layer payloads, and feeding summarized alert or anomaly data into the AFLE. In some implementations, a lightweight intrusion detection library is integrated directly into the fuzzy logic framework, thereby enabling the AFLE to interpret traffic anomalies as input variables akin to performance metrics. This multi-layer correlation step distinguishes the present embodiment from single-layer security solutions, allowing threats to be identified even when they manifest subtly across different layers of the network stack.

Upon identifying patterns that exceed predefined or dynamically updated threat thresholds, the AFLE automatically refines one or more membership functions to heighten security awareness. Specifically, membership function boundaries may be adjusted to label the current threat level as “medium” or “high” based on the degree of correlation among suspicious network- and application-layer signals. Once this threat status is determined, the action executor is promptly instructed to escalate security protocols system-wide, for instance by enforcing stronger encryption, limiting traffic from untrusted or newly suspicious devices, or even isolating compromised nodes into a quarantine subnet. Such reconfigurations typically occur in real time, minimizing the risk of lateral spread within the IoT environment. By integrating multi-layer security indicators into its fuzzy logic inference cycle, the system ensures that anomalous behavior is addressed swiftly and adaptively—a departure from static or single-layer security frameworks that may overlook subtle interactions among different layers.

In some embodiments, the learning module includes a predictive analytics model configured to forecast future network usage or device behavior. This model may be trained using historical data, real-time performance metrics (e.g., latency, packet throughput), and various contextual variables (for instance, time of day, device density, or environmental conditions). Employing techniques such as time-series analysis, regression methods, or more advanced machine learning algorithms (for example, LSTM neural networks), the predictive analytics model can identify trends or recurring patterns-such as daily traffic spikes or seasonal fluctuations—that indicate when network resources are likely to become strained.

From a hardware perspective, each gateway node or a designated analytics server may require multi-core CPU or GPU capabilities to train and run this predictive model without delaying the AFLE's real-time inference cycle. On the software side, open-source machine learning libraries (e.g., TensorFlow, PyTorch, or statsmodels) can be integrated into the learning module to facilitate model training, incremental updates, and rolling forecasts. Once trained, the predictive model continuously analyzes both live streaming data and historical logs to detect emerging patterns or future surges in network load.

Based on these forecasts, the adaptive fuzzy logic engine (AFLE) proactively updates its membership function boundaries before the system approaches critical performance thresholds. By narrowing or shifting the ranges for “medium” or “high” utilization in advance, the AFLE becomes more sensitive to early indicators of congestion or resource contention. Consequently, the AFLE can trigger interventions (such as, for example, bandwidth reallocation, device power adjustments, or load redistribution among multiple gateways) well before a noticeable degradation occurs. This preemptive strategy contrasts with reactive systems that only modify membership functions after performance suffers, enabling the system to achieve a smoother operational profile and to mitigate or even prevent many performance bottlenecks and abrupt disruptions in the IoT network.

In one illustrative embodiment, the network management framework operates across multiple tiers, combining localized edge intelligence with broader cloud-based analytics. At the edge tier, gateway devices or local controllers continuously gather immediate performance data—such as packet loss, device connectivity, or radio signal quality—from the IoT nodes physically nearest to them. Because these edge components are in close proximity to the devices they oversee, they can implement low-latency adjustments in near real time, mitigating issues such as sudden congestion or node failures before these conditions escalate. However, the edge tier typically operates under power and computational constraints, which can limit the scope and depth of the analytics performed locally.

In contrast, the cloud-based analytics layer aggregates a more extensive set of data spanning the entire IoT deployment, including historical logs and cross-regional performance metrics. With access to robust computational resources—such as high-capacity CPUs, GPUs, or other accelerators—the cloud can execute advanced machine learning models or large-scale statistical techniques to identify long-term trends, forecast usage spikes, or detect complex anomalies. When these cloud-level insights indicate that broader reconfiguration is needed-such as redistributing load, applying firmware patches, or updating membership function templates—the system transmits these directives back down to each edge gateway. Notably, the adaptive fuzzy logic engine (AFLE) that runs on the gateway can incorporate these directives by refreshing its local fuzzy rules or membership function boundaries, thus aligning the gateway's immediate decision-making with the global optimization goals deduced in the cloud.

A key novel aspect of this embodiment is how the AFLE reconciles urgent, site-specific actions at the edge with higher-level global strategies derived in the cloud. For instance, if the cloud predicts an imminent traffic surge across multiple regions, each relevant edge gateway can preemptively expand capacity, reassign device roles, or perform other measures before congestion materializes. Meanwhile, if a local edge node detects a sudden rise in packet loss, it can immediately reroute traffic or adjust transmit power—ensuring minimal latency for critical responses—even as it remains aligned with the overarching policies received from the cloud. This multi-tier coordination balances the edge's low-latency responsiveness against the cloud's capacity for in-depth analyses, producing a cohesive and efficient IoT network management solution.

From a resource perspective, each gateway node or edge device preferably includes sufficient computational power—such as a multi-core embedded processor—to run fuzzy inference and local data monitoring tasks. On the cloud side, higher-end server hardware equipped with ample memory or GPU capabilities may be beneficial for advanced data analytics, including machine learning-based forecasting or anomaly detection. Software components at the cloud tier typically include libraries and frameworks for processing large-scale data, whereas the edge tier maintains a lighter-weight version of the adaptive fuzzy logic engine capable of hot-loading updated membership function templates or fuzzy rules. The two tiers communicate via a standardized protocol (for example, RESTful APIs, MQTT, or a proprietary IoT messaging framework), ensuring that each local gateway can regularly report near-real-time performance statistics and receive refined or globally optimized parameters from the cloud. By integrating both local autonomy and global intelligence, this embodiment fosters timely local reactions to network events while steadily improving network-wide efficiency and resiliency over the long term.

In some embodiments, the adaptive fuzzy logic engine (AFLE) maintains layer-specific membership function subsets that respectively correspond to the physical, network, and application layers. For example, at the physical layer, membership functions may categorize signal-to-noise ratios into fuzzy sets such as “poor,” “moderate,” or “strong.” Meanwhile, the network layer may use an entirely different set of fuzzy partitions for congestion or routing metrics, and the application layer can define fuzzy sets relating to quality-of-service thresholds or user-perceived latency. By tailoring each subset of membership functions to the particular data patterns and constraints of its respective layer, the system obtains a more accurate and context-aware interpretation of real-time network conditions, as opposed to relying on a single, monolithic fuzzy logic model.

Once each layer's fuzzy inference outcome is generated, a weighted aggregation scheme combines these outputs into a unified decision. In scenarios where physical-layer interference emerges as the dominant factor behind recent performance declines, the AFLE may temporarily increase the weight assigned to physical-layer metrics. At the same time, application-layer indicators—such as user experience measures—remain part of the decision process to prevent undue neglect of service-level needs. These weights can be dynamically updated by the learning module based on evolving objectives—such as heightened security requirements or shifting traffic patterns—and near-real-time feedback from deployed IoT devices. By structuring fuzzy logic rules and membership functions around the individual nuances of each layer, the AFLE can simultaneously address severe issues (e.g., physical interference or acute application demands) without dismissing other ongoing network conditions.

From a hardware standpoint, each gateway node or edge computing device typically runs on a multi-core CPU that can handle the parallel processing demands of multiple membership function subsets. On the software side, a suitable fuzzy logic framework—such as an extended version of scikit—fuzzy or a similar library-enables the AFLE to store, update, and evaluate membership functions for each layer independently, before aggregating their outputs. The learning module may further incorporate machine learning tools or heuristic adaptation methods to analyze how changes to these membership functions and weight assignments affect observed performance. This multi-layer, weighted-aggregation approach thereby offers a more targeted and responsive strategy for IoT network management, in contrast to “one-size-fits-all” fuzzy logic engines that cannot prioritize or de-prioritize specific layers on demand.

The systems and methodologies disclosed herein—particularly those involving adaptive fuzzy logic engines (AFLEs), dynamic membership functions, learning modules, cross-layer analysis, and distributed action execution—may be advantageously applied to or adapted for use in web3 networks, which are typically decentralized, blockchain-based, or otherwise incorporate distributed ledger technology (DLT). Below is a description of some possible embodiments of this type.

In some embodiments, the adaptive fuzzy logic engine (AFLE) is deployed within permissionless blockchain networks (for example, Ethereum or Polygon) to address the dynamic resource and throughput management challenges that arise from unpredictable transaction volumes and fluctuating on-chain conditions. These blockchains frequently must fine-tune transaction throughput, block sizes, and fee structures in real time, particularly where node resources (CPU, memory) or network bandwidth vary widely between epochs. By integrating fuzzy logic-based decision mechanisms, the AFLE enables the blockchain to sense changes in transaction load, mempool congestion, or general chain performance, and adapt membership function parameters to label or prioritize network conditions (e.g., “low load,” “high load”) more appropriately as conditions evolve.

Specifically, the membership functions for “network load,” “gas fee levels,” or “block space availability” may be dynamically adjusted. For instance, if on-chain metrics such as mempool size, average block time, or pending transaction counts surpass certain thresholds, the AFLE may classify the situation as “high congestion.” In response, the system can automatically apply or recommend protocol-level modifications—like raising minimum fees, altering block size policies, or triggering alternative block production strategies—by referencing fuzzy rules that indicate how severely these congested states should influence the blockchain's behavior. Rather than rely on static thresholds for transaction throughput, the AFLE refines these membership functions on the fly to handle both short-lived traffic spikes and longer-term demand cycles.

Complementing this approach is a learning module that continuously refines the fuzzy logic rules and membership boundaries through the analysis of historical transaction data. Over time, the learning component identifies patterns in peak usage intervals, the network's behavioral changes following protocol upgrades, and normal fluctuations in user activity. As the module discovers effective strategies—such as incremental block size increases during peak hours or particular fee adjustments for certain mempool states—those insights are translated back into updated membership function shapes or revised inference rules within the AFLE. This iterative feedback cycle preserves the blockchain's decentralized character (by allowing multiple nodes or off-chain coordinators to contribute data) while dynamically optimizing resource usage, minimizing congestion, and stabilizing network throughput in an otherwise volatile environment.

In an exemplary implementation, each blockchain node or a subset of specialized validators runs an AFLE in tandem with the learning module. The node's local environment includes real-time data feeds (mempool statistics, gas fee metrics, and block production rates), which the AFLE interprets through dynamic membership functions describing, for example, network load or throughput capacity. Key hardware requirements include adequate CPU or GPU resources to conduct fuzzy logic inference and machine learning updates without impeding consensus. From a software standpoint, a suitable fuzzy logic library or framework—implemented in Python, C++, or another language—can integrate with the node's existing consensus protocol, exposing relevant metrics via APIs.

Because the system adjusts membership functions and inference rules iteratively, it requires a data logging mechanism to record performance outcomes—for instance, changes in block latency or transaction finality—after each adaptation. This data is fed into the learning module (which may rely on open-source machine learning libraries such as TensorFlow or PyTorch, or simpler evolutionary algorithm libraries). The module refines or recalibrates membership function boundaries based on observed effects on congestion or fee levels. Updated configurations are then transmitted among participant nodes, either through the blockchain's peer-to-peer network or a secure off-chain coordination layer. In this manner, the network maintains a decentralized structure while achieving enhanced dynamic resource allocation and throughput stabilization.

In another exemplary embodiment, the adaptive fuzzy logic engine (AFLE) is used to coordinate resource usage and finality times across Layer-1 (L1) and Layer-2 (L2) blockchain solutions, as well as potential cross-chain bridges that link separate networks. Because these different layers often operate under distinct throughput capacities, fee structures, and security parameters, synchronizing transactions and confirming state updates can prove difficult—especially when traffic surges or one layer is congested while the other is underutilized. To address these challenges, the system employs layer-specific membership function subsets for each blockchain or layer, treating, for example, Ethereum mainnet's confirmation times as one input, an L2's aggregator status as another, and cross-chain bridging throughput as yet another. By assigning these subsets to the AFLE, each layer or chain's performance is mapped into fuzzy sets (e.g., “low load,” “medium load,” “high load”) that dynamically evolve based on observed on-chain metrics, fees, and block intervals.

Once these fuzzy inferences are generated, the system employs a weighted aggregation procedure to arrive at coordinated decisions about bridging schedules, rollup transaction batching, or settlement intervals. For instance, if the AFLE detects that L1 gas fees have reached a high threshold while the L2 is approaching capacity, it can weight these conditions more strongly and adapt the bridging frequency or batch sizes accordingly, thus preventing either layer from being flooded. Conversely, if the L1 is relatively free but the L2 aggregator is heavily utilized, the system can delay certain layer-1 finalizations to avoid exacerbating L2 congestion. This approach ensures balanced cross-layer traffic flow and real-time responsiveness to shifting demands.

From a hardware perspective, each chain or layer may deploy a distributed set of gateway nodes or “fuzzy logic modules” capable of processing local load metrics and bridging requests. These gateways need sufficient CPU or GPU capacity to handle fuzzy inference calculations, albeit at a scale typically comparable to standard node operations. On the software side, a cross-chain analytics layer or aggregator regularly collects performance metrics (e.g., pending transactions, block finality times, bridging throughput) from each blockchain involved. A suitable fuzzy logic library—implemented in Python, C++, or another language—runs on these gateway nodes, ingesting the multi-chain data via APIs or message-passing protocols. A modest data logging and machine learning component may optionally refine membership function updates over time by analyzing historical bridging actions and on-chain conditions, thus improving the system's effectiveness at coordinating cross-layer operations.

In another illustrative embodiment, an adaptive fuzzy logic engine (AFLE) is applied to improve energy efficiency and node participation incentives within Proof-of-Stake (PoS) or Proof-of-Authority (PoA) blockchains. Because these networks depend on validators (or authorities) that commit resources to secure the chain, balancing node uptime, power consumption, and fair distribution of block rewards becomes paramount. By creating dynamic membership functions for node resource usage (CPU, memory) and consensus participation (e.g., percentage of blocks signed, missed attestation rates), the AFLE can identify underperforming or idling nodes and adjust node reward parameters accordingly. For instance, if the network detects an overabundance of inactive nodes, the fuzzy engine can shift the reward structure to favor validators demonstrating higher uptime or energy-efficient operation, incentivizing suboptimal validators to improve their performance or reduce consumption.

Moreover, the AFLE can incorporate a cross-layer security posture that blends chain-level security data (for example, repeated missed blocks or contradictory proposals) with broader network metrics (like latency spikes or suspicious traffic patterns). If validators demonstrate consistently anomalous behavior—such as failing to sign transactions in sync with other nodes or sending excessive, conflicting proposals—the fuzzy logic engine can escalate threat levels and trigger automated responses, including quarantining the offending node or initiating a slashing procedure. This arrangement offers a proactive, data-driven security mechanism well suited to PoS/PoA environments, where collective trust and participation are fundamental.

From a hardware standpoint, each validator or a dedicated set of monitoring agents can run the AFLE and the associated learning module, which collect usage metrics from node hardware (CPU, memory) and consensus logs (blocks missed, latency). This may be accomplished with validator monitoring agents operating at each participating node, reporting real-time performance data and event alerts to the fuzzy logic engine. On the software side, a suitable fuzzy logic framework and machine learning library (e.g., Python-based or integrated at the node level) processes these inputs, ranking or scoring validator behaviors via dynamic membership functions. Security modules (potentially using anomaly-detection algorithms or statistical analysis) may supplement the learning system by assigning fuzzy “threat levels” to suspicious validators, ensuring that both operational and security concerns factor into the adaptive consensus and reward decisions.

In yet another embodiment, the adaptive fuzzy logic engine (AFLE) is integrated into decentralized storage networks, such as IPFS, Filecoin, or Arweave, to optimize dynamic data placement among nodes with variable bandwidth, storage capacity, and reliability. Here, the system may define layer-specific membership functions for node attributes—e.g., “available disk capacity,” “retrieval latency,” and “replication factor”—using real-time telemetry from each storage node. These membership functions are continuously updated according to changing network conditions; for instance, if a particular region reports limited bandwidth or high node churn, the AFLE broadens the “high risk” fuzzy set for those nodes or localities, triggering a preference for alternative storage locations.

Weighted fuzzy rules enable adaptive placement decisions, taking into account multiple layers of data, including physical hardware constraints (disk space or power usage), network connectivity metrics (throughput, latency), and application-level usage patterns (frequency of retrieval requests or compliance requirements). Thus, even if a node exhibits limited free space but is known to have strong connectivity to end-users in a target region, the AFLE might still select it for a partial replication if the retrieval speed benefits outweigh the reduced storage margin. This adaptive approach helps balance data replication, overall network cost, and retrieval quality, without requiring purely manual or static configuration settings.

On the hardware side, each node—or a cluster of nodes—runs storage node telemetry software that collects disk usage statistics, node uptime, and retrieval performance. This telemetry is fed into the AFLE, which resides either in a centralized coordinator (if protocol designs permit) or in distributed “orchestrator nodes” that share fuzzy logic outcomes among participants. From a software perspective, the system may employ a fuzzy logic library that processes node telemetry and outputs dynamic data placement recommendations. A separate distributed orchestration layer then enforces these recommendations, instructing individual nodes on whether to replicate, move, or delete data blocks to maintain optimal redundancy and balanced load across the network. This integrated design ensures that data is adaptively distributed in a way that maximizes availability, minimizes latency, and respects local resource constraints.

In a further embodiment, the adaptive fuzzy logic engine (AFLE) is used to manage decentralized identity (DID) and reputation systems in Web3 environments, where user trustworthiness is derived from on-chain behaviors (e.g., transaction histories, contract interactions, staking patterns) and, in some cases, off-chain activities (such as reputation feeds from external services). Here, the learning module may monitor event logs and track various signals of user or node trust, such as governance proposal outcomes or frequency of blacklisted address interactions. Using fuzzy sets for “reputation level” (e.g., “high trust,” “medium trust,” “low trust”), the AFLE continuously adjusts membership function boundaries in response to newly observed data. For instance, if the network identifies repeated suspicious transactions linked to a user, the system expands that user's “low trust” membership function, triggering updates to their overall reputation score more rapidly than a purely static scoring model would.

The real-time adaptation enabled by dynamic membership functions also supports partial redemption if the user's subsequent transactions exhibit improved behavior. As the learning module receives continuing feedback, it recalibrates a user's fuzzy sets over time, ensuring that reputation metrics stay closely aligned with current network contexts, such as new roles the user takes on in governance or changes in protocol rules. From a hardware perspective, an identity oracle or aggregator may operate on dedicated servers or across validator nodes, consolidating user-related data from multiple blockchains or off-chain sources (e.g., social signals, KYC providers). On the software side, consensus-level hooks or smart contracts can be designed to react automatically whenever the AFLE signals that a user's trust tier has changed—for example, restricting certain governance actions until the user's behavior improves or requiring additional confirmations for high-value transactions. This combination of fuzzy logic-based scoring, continuous learning, and automated responses offers a more nuanced approach to DID and reputation than static or purely numeric models.

In another exemplary embodiment, the adaptive fuzzy logic engine (AFLE) is integrated into Decentralized Autonomous Organizations (DAOs) to enhance governance processes and decision outcomes. Because DAO participation can fluctuate and proposal outcomes may be influenced by short-term sentiment swings, the AFLE defines dynamic membership functions for factors like “community engagement,” “proposal complexity,” or even “economic tension” in the broader market. For instance, if voter turnout is trending low and a proposal is particularly time-sensitive, the AFLE can reduce the quorum or majority requirements to expedite necessary actions. Conversely, for proposals deemed high risk or more complex, the AFLE may raise voting thresholds to ensure broader participation or additional scrutiny.

Such adaptive voting thresholds are managed by fuzzy rules that weigh real-time data from DAO analytics tools, which monitor user engagement (e.g., how many wallets are active, how many tokens are voted), proposal timing, token distributions, and on-chain sentiment (including token price fluctuations or current gas fees). A learning module refines these fuzzy rules by identifying which aspects of proposals consistently drive contention. For example, if it detects that token redistribution proposals become heated whenever gas prices spike, the module can adjust membership functions to place additional weight on “economic tension,” prompting the system to alert voters or encourage extended discussion.

From a hardware perspective, nodes responsible for DAO governance (such as specialized validator or coordinator nodes) host the AFLE and the learning module. They require enough CPU and memory resources to process live engagement metrics and promptly update fuzzy logic parameters without disrupting governance workflows. On the software side, fuzzy governance contracts on the blockchain can encode the logic for quorum or supermajority thresholds, referencing membership function outputs via an API or an oracle-like feed from the AFLE nodes. As a result, the DAO's governance framework remains dynamic, automatically scaling governance requirements in line with user participation levels, proposal complexity, and broader market forces.

In yet another embodiment, the adaptive fuzzy logic engine (AFLE) is incorporated into Decentralized Finance (DeFi) platforms to enhance cross-layer security and fraud detection. Complex smart contracts, liquidity pools, and multi-step financial transactions create numerous vectors for exploits such as flash-loan attacks, frontrunning, or other manipulations. By defining fuzzy sets for on-chain indicators (for example, large, unexpected liquidity movements or anomalous token price shifts), network layer metrics (for example, rapid surges in transactions from suspect addresses or repeated failed contract calls), and application-level logs (for example, abrupt spikes in unusual function calls), the AFLE can detect correlated anomalies that suggest emerging threats. Whenever these correlated signals exceed a fuzzy “medium” or “high” threat threshold, the system may block particularly risky operations, reduce transaction limits, or require additional verifications, thereby preventing attacks from escalating into network-wide losses.

Beyond mere detection, the AFLE also supports adaptive tuning of DeFi contract parameters, such as dynamic adjustments to slippage tolerances in decentralized exchanges (DEXs). If the fuzzy engine infers, from data on mempool activity and recent liquidity usage, that the conditions for frontrunning or flash-loan exploitation are high, it can temporarily tighten slippage or impose stricter transaction size limits. This real-time adaptation mitigates potential attacks or arbitrage manipulations without halting the contract entirely, allowing legitimate traders to continue operating under safer conditions.

It is noted that slippage tolerance is a parameter commonly used in decentralized exchange platforms that specifies the maximum acceptable deviation between the expected execution price of a trade and the actual price at which the trade is executed. For example, if a trader sets a slippage tolerance of 1%, the trade will only execute if the final price remains within 1% of the initially quoted price. This mechanism protects users from unexpected price fluctuations that can occur during the time delay between order submission and execution.

In practical terms, examples of slippage tolerances might include settings of 1%, 0.5%, or even 0.25%, depending on the trader's risk appetite and market volatility. To mitigate exploit potential, particularly in environments susceptible to rapid price movements or front-running attacks, these tolerances can be tightened. Tightening the slippage tolerance involves reducing the allowable percentage deviation; for example, lowering the tolerance from 1% to 0.5% or even 0.25% can help ensure that trades are executed at prices closer to the expected value. By doing so, the system minimizes the opportunity for attackers to manipulate prices or execute flash loan attacks, thereby enhancing overall market stability while still facilitating legitimate transactions under more controlled conditions.

In addition to restricting large swaps and flash loans, the AFLE (or an automated response module associated with it) may be configured to temporarily limit other high-risk operations to further mitigate exploit potential. For example, the module may restrict margin and leveraged trading by limiting or suspending the initiation of new leveraged positions during periods of detected instability, thereby reducing systemic risk. Furthermore, the module may pause or modify automatic collateral liquidation triggers in lending protocols to prevent cascading liquidations during periods of extreme market volatility.

Additionally, the system could impose restrictions on operations such as liquidity pool rebalancing or removals by temporarily limiting sudden large-scale liquidity movements that might destabilize pool ratios. The module may also restrict staking and yield farming activities by capping new participations or suspending additional incentives to manage exposure during heightened threat conditions. Other measures might include imposing tighter controls on protocol-driven token minting or burning operations, as well as deferring the execution of high-impact governance proposals until further review or human confirmation is obtained. These additional safeguards ensure that the system maintains overall stability and resilience by dynamically adjusting protocol operations in response to real-time threat assessments, while still allowing legitimate transactions to continue under controlled conditions.

From a hardware standpoint, a security oracle or intrusion detection library can run alongside the AFLE, parsing DeFi transactions and events for suspicious patterns at each node (or at specialized nodes). These analyses feed into the fuzzy logic engine, which issues rapid updates to the network or contract configurations. In terms of software requirements, the DeFi platform should incorporate permissioned or hybrid execution mechanisms that allow for partial automatic responses (like restricting suspicious trades) while deferring larger-scale interventions (such as freezing certain liquidity pools) to human governance reviews if the AFLE flags a critical threat level. This combination of fuzzy logic-based rule sets and machine learning-driven adaptation yields a more proactive, fine-grained security approach in DeFi ecosystems, reducing the risk of devastating exploits while minimizing user disruption.

One skilled in the art will appreciate that On-chain liquidity shifts refer to significant changes in the balance of assets within decentralized finance (DeFi) protocols, as recorded directly on the blockchain. These shifts may be detected by monitoring the inflows and outflows of tokens from liquidity pools, smart contracts, or decentralized exchanges. For example, a sudden, large withdrawal of funds from a liquidity pool may indicate an emerging threat or an attempted exploit, while an unexpected surge in deposits might signal a coordinated trading or arbitrage strategy. The detection of these liquidity shifts involves aggregating and analyzing real-time on-chain data, identifying deviations from typical liquidity patterns, and correlating such changes with other market indicators to determine potential risks.

Network-layer address anomalies are indicators derived from analyzing the behavior of blockchain addresses at the network level. These anomalies may include unusual patterns such as a sudden increase in the number of transactions from a specific address, abnormal clustering of transactions between a set of addresses, or atypical geographic or IP-based patterns that deviate from normal network behavior. Such anomalies may signal the presence of automated bots, coordinated attacks, or fraudulent activities such as phishing or spoofing. By continuously monitoring address activities and employing statistical models or machine learning techniques to establish baseline behaviors, the system can flag addresses that exhibit significant deviations, thereby enabling timely interventions to protect the network.

Application-layer contract logs comprise the detailed records generated by smart contracts during their execution, which capture events such as function calls, state changes, and emitted event data. These logs provide granular insights into the operations occurring within the decentralized application (dApp) environment. For example, an unusual frequency of error logs or irregular function execution patterns may indicate attempts to exploit vulnerabilities in the contract code, such as reentrancy attacks or flash loan exploits. By systematically analyzing these logs in real time, the system can detect patterns or anomalies that deviate from normal contract behavior. Such monitoring enables rapid identification of potential security breaches at the application level, thereby facilitating preemptive measures to mitigate exploit risks and maintain system integrity.

Beyond the previously described indicators, the system may incorporate additional multi-layer indicators to further enhance threat detection and adaptive security measures. At the on-chain level, the system may monitor for abrupt fluctuations in transaction volume, anomalous gas fee spikes, or unusual patterns in token minting and burning operations. These indicators can serve as early warnings of potential market manipulations or network congestion that may precede exploit attempts. Similarly, sudden changes in cross-chain bridge activity or inter-block time variations can provide further insight into emerging systemic risks within decentralized networks.

At the network layer, supplementary indicators might include deviations in data packet transmission rates, unexpected increases in latency, and irregularities in node connectivity or block propagation times. For example, uncharacteristic delays in transaction confirmation or inconsistent communication between nodes could indicate network-level attacks such as Distributed Denial-of-Service (DDoS) or targeted manipulation efforts. Continuous monitoring of these parameters helps the system identify subtle disturbances that may serve as precursors to larger security breaches.

At the application layer, additional indicators extend beyond traditional contract logs to include anomalous patterns in user behavior analytics and API usage. Abnormal shifts in governance voting patterns within decentralized autonomous organizations (DAOs), unexpected variations in transaction success rates, or sudden modifications in fee structures can all signal potential exploit activities. By aggregating and correlating these diverse multi-layer indicators, the system constructs a comprehensive, real-time threat profile that enables dynamic adjustments to security protocols and mitigates exploit potential while maintaining operational continuity.

Some embodiments of the systems and methodologies disclosed herein may reference “extreme threat levels”. This term may be defined in several alternative manners to facilitate robust security responses under varying conditions. One approach involves employing a composite risk index that aggregates multiple multi-layer indicators (such as, for example, significant on-chain liquidity outflows, unusual network-layer address activity, and irregular application-layer contract log events) by assigning each indicator a weighted score. When the cumulative score exceeds a predetermined threshold, the system categorizes the situation as an extreme threat. This method allows the system to adapt to the relative severity of anomalies across different layers, ensuring that a critical combination of events triggers a fallback governance mechanism.

Alternatively, extreme threat levels may be defined using statistical deviations from established baseline behaviors. For example, thresholds can be set such that if observed metrics-such as liquidity shifts, transaction volumes, or node activity rates-deviate by more than a predefined number of standard deviations (e.g., two or three standard deviations) from the historical mean, the threat level is classified as extreme. This statistical approach allows for dynamic adjustment based on the evolving state of the network while providing a clear, quantifiable trigger for human intervention or partial freezing of contract functions.

A further definition can be implemented through the use of a fuzzy logic engine that assigns threat levels based on the degree of membership within predefined fuzzy sets (e.g., “low threat,” “medium threat,” “high threat,” and “critical”). When the adaptive fuzzy logic engine outputs a fuzzy value that exceeds the threshold corresponding to the “critical” classification, the system interprets this as an extreme threat level. This method leverages the inherent uncertainty in network conditions by smoothly transitioning between threat states and enabling real-time, context-aware decision-making.

Additionally, extreme threat levels may be determined by adaptive thresholds that are continuously recalibrated through machine learning algorithms. In this approach, historical network data is used to continuously update threshold values for various indicators. If real-time measurements exceed these dynamically adjusted thresholds (for example, if liquidity shifts or transaction anomalies surpass the most recent predictive benchmarks), the system designates the threat level as extreme, triggering pre-configured fallback governance actions.

Each of these definitions provides a systematic basis for recognizing when network conditions have escalated to an extreme threat level, thereby ensuring that the fallback governance mechanism activates only under situations that present a high risk of systemic exploitation, while still permitting legitimate transactions to proceed with minimal disruption.

The systems and methods disclosed herein (which are centered on adaptive fuzzy logic engines with dynamic membership functions, iterative learning, cross-layer optimization, and distributed action execution) lend themselves naturally to Web3 applications where decentralized governance, volatile workloads, and complex multi-layer interactions prevail. By applying fuzzy logic-based adaptation, multi-objective optimization, and real-time feedback loops, Web3 networks can manage resource constraints (throughput, gas, computing cycles), security postures, or node participation incentives in a more granular, data-driven manner.

In Web3 applications, node infrastructure may require enough computational headroom to run fuzzy logic inference and machine learning-based optimization. While many Web3 nodes are resource-constrained, deploying specialized edge gateways or partial off-chain logic can balance performance and decentralization goals.

Interoperable libraries and analytics tools may be critical for feeding real-time blockchain metrics (mempool data, consensus states, transaction analytics) into the AFLE. In addition, the learning module may rely on ephemeral or permanent data from distributed ledgers, oracles, and cross-chain indexing services. In this manner, the adaptation and intelligent control concepts disclosed herein, including dynamic membership functions, hyperparameter optimization, feature importance ranking, and multi-layer synergy, may be extended or reimagined to meet Web3-specific needs around scalability, security, governance, and resource management, all in a decentralized and trust-minimized environment.

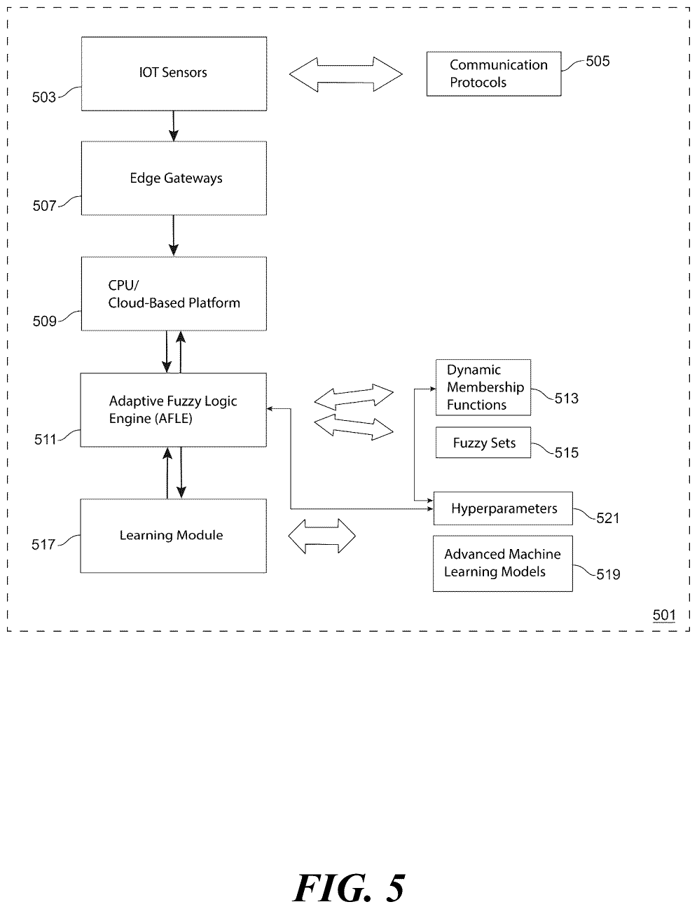

FIG. 5 depicts a particular, nonlimiting embodiment of a system for managing Internet of Things (IoT) networks adapted for use in a smart city IoT network management platform. The platform 501 is designed to dynamically optimize urban infrastructure such as traffic control, public lighting, environmental monitoring, and energy distribution. In this application, a vast array of IoT sensors 503 is deployed throughout the city to continuously measure parameters such as traffic density, vehicle speed, ambient light, air quality, and energy usage. These sensors 503 transmit real-time data via secure, low-latency communication protocols 505 (e.g., MQTT or LoRaWAN) to local edge gateways 507. The edge gateways 507 perform preliminary data aggregation and processing before forwarding the consolidated information to a central processing unit or cloud-based platform 509.

At the heart of the system, the adaptive fuzzy logic engine (AFLE) 511 uses dynamic membership functions 513 to translate the continuous and often ambiguous sensor data into fuzzy sets 515 (such as, for example, “low,” “medium,” or “high” traffic congestion or energy consumption levels). Concurrently, a learning module 517 employing advanced machine learning models 519 evaluates the performance of these membership functions against predetermined performance metrics (e.g., network latency, resource utilization, or energy savings). The learning module 517 iteratively adjusts the hyperparameters 521 that govern the shape and thresholds of the dynamic membership functions 513 through a hyperparameter optimization process. This process may employ techniques such as Bayesian optimization, grid search, or evolutionary algorithms to select the hyperparameter values that maximize overall system performance and adaptability.

Significant hardware resources for this application include a network of high-fidelity IoT sensors, robust edge computing devices or gateways with multi-core processors and, where necessary, GPU acceleration for local machine learning computations, as well as central servers or cloud platforms capable of handling large-scale data aggregation and intensive hyperparameter optimization routines. On the software side, the implementation requires suitable machine learning frameworks (such as, for example, TensorFlow or PyTorch), fuzzy logic libraries (such as, for example, MATLAB's Fuzzy Logic Toolbox or open-source alternatives), and hyperparameter optimization tools (such as, for example, Optuna or Hyperopt) integrated with real-time data analytics and visualization dashboards for network administrators.

The interaction between these components is crucial for realizing the end-use application. Real-time sensor data is continuously collected and processed by the AFLE 511, which uses its current set of dynamic membership functions 513 to assess urban conditions. The learning module 517 analyzes the outcomes of the AFLE's decision-making (such as, for example, adjustments made to traffic signal timings, public lighting intensities, or energy distribution protocols) and, by evaluating these outcomes against performance benchmarks, identifies opportunities to refine the hyperparameters 521 governing the membership functions 513. Optimized hyperparameters 521 are then fed back into the AFLE 511, allowing the system to iteratively learn and adapt to changing urban dynamics. This continuous feedback loop ensures that the system maintains optimal performance, reduces congestion, enhances energy efficiency, and improves overall service delivery in the smart city environment while automatically mitigating risks associated with fluctuating network conditions.

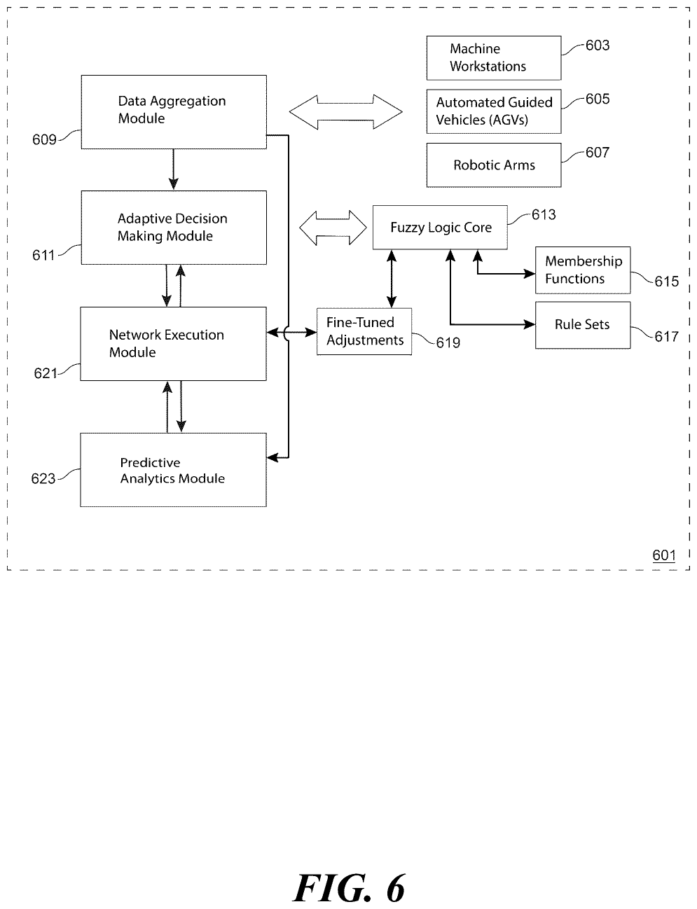

FIG. 6 depicts a particular, nonlimiting embodiment of an autonomous network adjustment system for Internet of Things (IoT) networks adapted for use in a “Smart Factory” scenario. In this particular scenario, a large number of industrial sensors, actuators, and machines operate on a shared IoT network to coordinate production, assembly, and logistics tasks. In this environment 601, each machine workstation 603 may generate real-time data on metrics such as temperature, vibration, throughput, and error rates, while automated guided vehicles (AGVs) 605 and robotic arms 607 likewise report location, payload status, and power consumption.

A data aggregation module 609 continuously collects these real-time feeds (possibly augmented by historical performance logs) and normalizes the disparate data into a standardized format. This module might run on a cluster of edge servers or a local industrial gateway device with sufficient computing power to handle the high volume of sensor data. On the software side, an IoT data pipeline framework (e.g., Apache Kafka or MQTT brokers) may manage the transport and filtering of data, while a time-series database or relational database system stores both current and historical observations.

An adaptive decision-making unit 611 equipped with a fuzzy logic-based processing core 613 analyzes the aggregated data to identify emerging bottlenecks or inefficiencies in the factory floor's network usage, such as unbalanced throughput among machines or bandwidth constraints affecting sensor accuracy. The fuzzy logic core 613 dynamically updates its membership functions 615 or rule sets 617 to classify states like “low load,” “medium load,” or “high load,” and then prescribes fine-tuned adjustments 619. For example, if the fuzzy inference detects a persistent backlog of assembly tasks in one production line, it may recommend redistributing workloads or rerouting data traffic to less busy segments. These adjustments occur continuously and adaptively, even as new data arrives, ensuring that the factory's operational conditions are always being re-assessed.

Once a decision is reached, a network execution module 621 automatically implements the necessary configuration changes throughout the IoT infrastructure. Concretely, this might involve directing AGVs to alternate paths for material transport to reduce congestion, adjusting machine cycle times to even out production rates, or allocating additional wireless bandwidth to particularly critical sensors. These decisions are carried out with minimal human intervention, thanks to standardized control protocols that interface directly with the factory's programmable logic controllers (PLCs), industrial switches, and router configurations.

In parallel, a predictive analytics module 623 forecasts upcoming network conditions (such as, for example, anticipated spikes in data traffic, machine downtime, or changes in workflow demands) by applying machine learning algorithms (for example, random forests or LSTM networks) to the historical data and real-time sensor feeds. As the module identifies trends or cyclical patterns (for example, heavier production loads during a particular shift or an impending maintenance schedule), it notifies the adaptive decision-making unit 611, enabling proactive configuration adjustments before bottlenecks occur.

In terms of hardware resources, the system typically requires (1) robust industrial IoT sensors and devices capable of capturing production metrics accurately and operating in challenging factory environments, (2) edge computing nodes or a local data center with multi-core CPUs (and, if required, GPU acceleration) for running fuzzy logic inferences and machine learning workloads, and (3) a reliable communication infrastructure (wired Ethernet or industrial wireless protocols) to ensure low-latency and fault-tolerant data exchange. On the software side, the solution may incorporate containerization platforms (such as, for example, Docker or Kubernetes) to manage microservices for data aggregation, fuzzy logic processing, predictive analytics, and network execution tasks. Integration with an industrial control platform or SCADA system may also be vital for seamless oversight of factory-floor processes.

The interaction among these components establishes a continuous optimization loop: the data aggregation module 609 supplies the adaptive decision-making unit 611 and predictive analytics module 623 with fresh insights, the fuzzy logic engine 613 dynamically refines operational rules to address immediate issues, and the network execution module 621 applies the optimized changes in real time. Consequently, the factory can balance workloads, reduce downtime, and improve overall efficiency with minimal manual intervention. This represents a powerful, autonomous solution for modern industrial IoT network management.

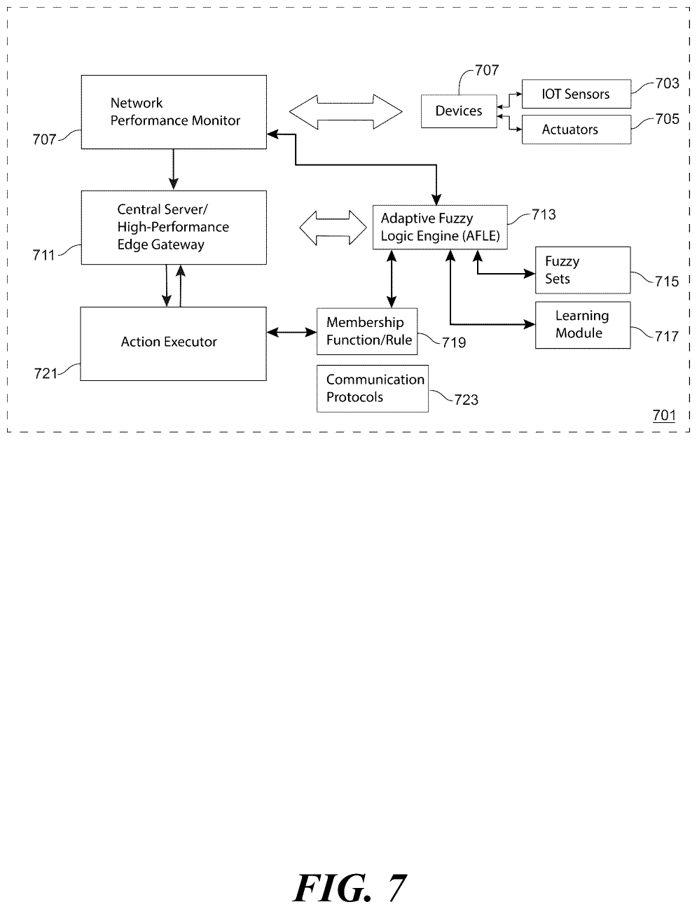

FIG. 7 depicts a particular, nonlimiting embodiment of a system for managing Internet of Things (IoT) networks 701 adapted for use in a smart agriculture environment. In this environment, a large-scale farm integrates numerous IoT sensors 703 and actuators 705 to optimize irrigation, pest control, and resource consumption. In this setting, the farm is outfitted with devices 703 such as soil-moisture probes, weather stations, and crop health sensors, all of which supply real-time data (such as, for example, water usage, rainfall, nutrient levels, ambient climate readings) to a network performance monitor 707. The network performance monitor 707 continuously collects and normalizes these metrics, while also correlating them with contextual information such as weather forecasts or scheduled irrigation cycles, thereby providing an accurate overview of the network's status and the agricultural environment.

A central server or high-performance edge gateway 711 hosts the adaptive fuzzy logic engine (AFLE) 713, which ingests the incoming sensor data from the network performance monitor 707. Utilizing dynamic membership functions, the AFLE 713 classifies both the network and agricultural parameters into fuzzy sets 715 (for example, “low moisture,” “optimal moisture,” “excessive moisture,” or “low bandwidth”), thereby accounting for communication constraints as well as field conditions. This fuzzy-based interpretation enables more nuanced decision-making than traditional binary thresholds. In order to refine these classification boundaries and rules over time, a learning module 717 continuously analyzes the effectiveness of the AFLE's past decisions. For instance, if delaying irrigation in one sector negatively affects crop yield, the learning module 717 will adjust the membership function or rule 719 that previously deemed the soil “adequately moist.” Conversely, if overwatering leads to nutrient leaching, the “excessive moisture” threshold is tightened. Through this iterative cycle, the AFLE 713 remains sensitive to evolving environmental factors and network loads, thus ensuring improved resource allocation and stable system performance over time.

An action executor 721 implements the AFLE's decisions by reconfiguring the IoT network 701 and controlling the farm's processes. By way of illustration, the executor 721 may direct edge gateways 711 to modify sensor polling frequencies, reroute data traffic, or remotely activate irrigation valves. These commands are typically transmitted via standardized communication protocols 723 (for instance, MQTT or Modbus), so that the network and field devices can adapt rapidly to new instructions. The executor 721 logs the outcomes of each intervention, feeding this performance data back to the learning module 717 to further enhance future decisions and rules.

Several important hardware and software resources facilitate such an implementation. The farm must deploy robust IoT sensors and actuators, including soil moisture, pH, temperature, humidity, and crop health sensors, along with automated valves, pumps, and climate-control systems in greenhouses. Edge gateways or local servers equipped with multi-core processors, adequate RAM, and network interfaces (4G/5G, Wi-Fi, or LPWAN) enable local data aggregation and partial fuzzy logic inference. A central computing infrastructure, whether on-premises or in the cloud, provides the CPU/GPU resources required for more complex analytics, with databases (e.g., relational or NoSQL systems) supporting both historical and real-time data operations. From a software standpoint, the farm may rely on fuzzy logic and machine learning libraries (such as, for example, scikit-fuzzy, TensorFlow, or PyTorch), data collection and monitoring tools (such as, for example, Prometheus or MQTT brokers), and APIs or messaging protocols (such as, for example, REST, gRPC, MQTT) to orchestrate sensor data transfers and device commands.

Collectively, these components operate in a closed-loop manner. The network performance monitor 707 supplies the AFLE with up-to-date system and field information, the AFLE 713 makes real-time decisions based on fuzzy logic interpretations, the learning module 717 continuously refines membership functions and rules 719 by analyzing past performance, and the action executor 721 enforces adjustments across the network and field equipment. As a result, the smart agriculture system incrementally improves irrigation scheduling, reduces input waste, and increases overall crop yields by adapting in real time to changing environmental conditions and network constraints.

The following is a representative end-use scenario of a system of the type disclosed herein for cross-layer security adaptation implemented within a decentralized finance (DeFi) lending protocol that provides peer-to-peer borrowing, lending, and yield farming across multiple on-chain liquidity pools. Users deposit various cryptocurrencies as collateral, while smart contracts automate loan issuance, interest accrual, and the flow of funds among different pools. A central element of this arrangement is the adaptive fuzzy logic engine (AFLE), which monitors multi-layer indicators including on-chain liquidity shifts (for example, large or sudden outflows from lending pools), network-layer address anomalies (for example, clustering of high-value transactions from a small set of addresses), and application-layer contract logs (for example, unusually frequent error events or function calls).

The AFLE employs dynamic membership functions that label each detected anomaly on a continuum ranging from “low threat” to “critical,” a process that accounts for correlations between signals at different layers. For instance, if the system detects abrupt liquidity withdrawals coinciding with repeated reentrancy-related errors in contract logs, it may elevate the overall risk level to “critical.” Once the AFLE's fuzzy output surpasses a threshold, an automated response module immediately restricts certain DeFi operations (such as large swaps, flash loans, or leveraged trades) or tightens slippage tolerances, mitigating the potential for frontrunning or other exploitative behaviors.

In cases where the AFLE classifies a situation as an extreme threat, the system activates a fallback governance mechanism that partially freezes high-risk protocol functions or requires human confirmation (e.g., multi-signatory approvals or a DAO vote) before executing significant contract actions. By applying this tiered approach, the protocol preserves essential services for legitimate users under normal and moderately elevated threat conditions, yet retains the ability to impose more drastic measures when severe security risks arise.

Implementation of this system typically involves a suite of hardware and software resources. At the hardware layer, nodes or off-chain servers run the AFLE, supplemented by secure communications and anomaly detection modules that parse on-chain, network-layer, and contract-level data. On the software side, machine learning libraries (such as scikit-fuzzy or TensorFlow) facilitate the dynamic membership functions, while additional frameworks (like Optuna or Hyperopt) may optimize thresholds as new threats emerge. The governance layer leverages smart contracts with partial freeze capabilities or human confirmation workflows, ensuring that fallback measures can be invoked rapidly when warranted.

A multi-step process underlies the system's operation. First, data streams from on-chain events, network-layer reports, and contract logs are aggregated, granting the AFLE a holistic view of potential security events. Second, fuzzy logic categorization (guided by dynamic membership functions) assigns a composite threat level. Third, the automated response module reacts proportionately to the assessed threat by restricting sensitive operations (for example, limiting flash loans or adjusting slippage parameters). Finally, if the AFLE designates an extreme threat level, the fallback governance mechanism initiates partial freezes or escalates the procedure for human confirmation of high-impact functions. Through these interconnected layers of monitoring, fuzzy classification, responsive action, and governance oversight, the DeFi lending protocol adapts in near real time to evolving threats while striving to maintain uninterrupted service for honest participants.

In certain embodiments, the disclosed method for adaptively managing DAO governance parameters may be applied to a community-driven investment DAO, such as one referred to herein as “FundingCloud.” In this exemplary implementation, the DAO collects a range of engagement data, including on-chain metrics (e.g., voting turnout, token distribution) and off-chain metrics (e.g., forum discussions, proposal complexity indicators). A fuzzy logic engine defines membership functions for at least “community participation” and “proposal urgency.” These membership functions adapt over time by referencing current and historical engagement patterns, thus dynamically classifying proposals into categories indicating, for example, high-impact or time-sensitive content.

Once proposals have been classified, the fuzzy logic engine automatically adjusts governance thresholds—such as quorum requirements or extended voting windows—to better align with the current level of turnout or risk associated with each proposal. In practice, if participation is detected to be low but the proposal is deemed significant (e.g., a token redistribution measure), a higher quorum or additional voting time may be required. Conversely, where participation is high and urgency is elevated, voting deadlines may be shortened while still mandating a supermajority. A dedicated learning module analyzes prior voting outcomes to identify factors (such as controversial treasury changes) that have historically driven contention. In such instances, the membership functions are reweighted to emphasize the relevant economic tension, thereby ensuring future proposals of a similar nature receive appropriately stringent participation thresholds.

Implementing this system involves both on-chain and off-chain components. At a high level, smart contracts monitor and enforce dynamic voting rules, while off-chain servers or oracle services collect engagement metrics and run the fuzzy logic inference routines. Hardware resources can include validator nodes and edge computing devices, as well as conventional servers for off-chain analytics. Software components may include libraries or frameworks to implement fuzzy logic membership functions, alongside a learning algorithm for reweighting said functions in real time. These tools allow the DAO to maintain a robust, adaptive governance process that matches real-world conditions, reducing the risk that a small subset of voters quickly approves major decisions or that inconsequential proposals stall under excessively rigorous voting requirements.

In one exemplary implementation, the disclosed system for decentralized identity and reputation scoring is deployed in a permissionless, Web3-based lending platform referred to herein as “TrustLend.” In this environment, users regularly engage in on-chain transactions (for example, initiating loans or providing collateral), as well as participating in governance discussions and votes. TrustLend's identity oracle continuously collects these on-chain interactions, as well as optional off-chain data such as social media attestations or anti-money-laundering “watch list” checks. The oracle aggregates the resulting data into a user profile that captures the user's historical behavior (e.g., timely loan repayments, frequency of interacting with blacklisted addresses) for further analysis.

Once the user profile data is assembled, it is passed to an adaptive fuzzy logic engine (AFLE). This engine assigns each user to one of three fuzzy trustworthiness categories-“high,” “medium,” or “low.” Rather than relying on fixed thresholds, the AFLE dynamically updates membership function boundaries in response to new event logs. For example, if the oracle detects that a user has recently transacted with a flagged address, the AFLE may shift the user's trust level downward, even if prior indicators were generally positive. The fuzzy logic rules defining these classifications also incorporate levels of correlation: a single suspicious event may not suffice to reduce a user's rating, but correlated negative signals (such as multiple interactions with malicious contracts) can trigger an immediate downgrade.

Supporting this process is a learning module that continuously analyzes both aggregate blockchain data and individual user histories to recognize new patterns of suspicious behavior. If the module identifies an emerging tactic for obscuring illicit activities (e.g., repeated use of privacy-focused tokens followed by bridging into a blacklisted address), it will modify membership function weighting so that the AFLE becomes more sensitive to this pattern. Consequently, the system can adapt to newly observed exploits in near real time, rather than awaiting manual updates to blocklists or static reputation scores. Critically, this learning mechanism enables the AFLE to remain effective in the face of ever-evolving schemes designed to bypass conventional rules-based checks.

At the blockchain layer, one or more consensus-level hooks or smart contracts validate each user's fuzzy classification. A user found to have “high” trust (based on consistent, legitimate on-chain interactions) would typically be granted seamless access to lending, staking, or governance privileges. Conversely, a user who falls below a defined threshold (for example, “low” trust) may be restricted from initiating large-value transactions, or be prompted for additional authentication steps (such as identity verification through trusted off-chain providers). These consensus-level checks ensure that malicious or compromised accounts are quarantined or required to prove trustworthiness, thereby preserving the integrity and security of the broader DeFi ecosystem.

Several hardware and software resources may be leveraged to implement this system. First, validator nodes on the underlying blockchain maintain consensus and execute the smart contracts containing the trust-based enforcement logic. Off-chain oracles or specialized servers equipped with sufficient compute power (multi-core CPUs, GPU resources if machine learning tasks are intensive) host the AFLE and the learning module. These off-chain components rely on libraries (e.g., scikit-learn, TensorFlow, or PyTorch) for pattern recognition, as well as fuzzy logic frameworks that enable real-time membership function adjustments. When integrated, the identity oracle uses standard cryptographic APIs, bridging user data and blacklist information from external sources. The AFLE, in turn, processes these inputs and updates its fuzzy classification boundaries accordingly, feeding back the results to the consensus-level hooks for on-chain enforcement. This interoperability and continuous feedback loop results in a robust, self-adapting reputation scoring process across permissionless Web3 networks.

In one illustrative deployment, the disclosed system for adaptive data placement in decentralized storage networks is utilized by a large multinational media streaming service, referred to here as “MediaGrid,” to store and retrieve high-resolution video segments across a geographically distributed set of storage nodes. MediaGrid's infrastructure comprises a global network of participant nodes, each equipped with node telemetry software that monitors disk capacity, throughput, current upload/download bandwidth, and recent retrieval latencies. This telemetry is conveyed to an adaptive fuzzy logic engine (AFLE), which dynamically classifies each node's suitability for storing or replicating media blocks.

Each node runs a lightweight monitoring agent that reports time-varying data such as free disk space, current bandwidth utilization, and an average of retrieval latencies for past user requests. In scenarios where node churn is high (i.e., nodes frequently joining or leaving), the telemetry agent also flags transient conditions-such as a node signaling upcoming downtime—to the central system or local coordinating peers. The AFLE then defines membership functions for node “storage status” (covering parameters like remaining disk capacity), “replication factor” (indicating how many copies of data should be kept), and “retrieval performance” (capturing latency and bandwidth conditions). These membership functions are updated in real time. For instance, if telemetry reveals that a node's bandwidth availability is trending downward, its “high-throughput” fuzzy membership may shift to “moderate” or “low,” thus prompting subsequent data placement decisions to prioritize other, more capable nodes. Likewise, a node showing consistent downtime might receive a lower membership rating under “node reliability,” in turn reducing the replication load it is assigned.

The AFLE employs fuzzy rules that weigh data from multiple layers: (1) physical layer data (e.g., disk usage) to determine whether a node can still accommodate additional content; (2) network layer data (e.g., connectivity status, bandwidth) to gauge how efficiently the node can serve requests; and (3) application patterns (for example, trending retrieval requests from a particular region) to decide whether a given node's geographic location can deliver content faster to localized user clusters. By way of example, if the fuzzy logic inference detects “medium disk usage” but “high bandwidth availability” on a node near a sizable user base, the system may prioritize placing frequently accessed video segments there to minimize retrieval latency. Furthermore, the fuzzy logic rules incorporate dynamic coefficients to decide whether the system should prioritize reliability (namely, the number of replicas to maintain) or retrieval speed by placing data closer to the majority of viewers. If real-time data reveals an ongoing event driving heavy streaming demand in Asia, the AFLE may reassign membership function boundaries so that nodes in that region with “moderate” capacity become favored targets, ensuring faster local retrieval even if this slightly reduces the global distribution balance.

A distributed orchestration service (running atop a decentralized protocol such as IPFS, Filecoin, or a proprietary DHT system) executes the AFLE's directives, replicating or moving data blocks among storage nodes to balance reliability and retrieval latency. Each node receives periodic placement instructions (for example, “replicate file block X from Node A to Node B,” or “reduce the copy count of block Y on Node C”) derived directly from the fuzzy logic output. Rather than blindly maintaining a fixed replication factor, the system adjusts the number of copies based on real-time events. If a node signals upcoming downtime, the orchestration quickly pushes extra copies of that node's data to other stable peers. Conversely, when usage patterns change and certain content is rarely requested, the fuzzy inference may reduce replication on high-throughput nodes, thereby freeing their resources for hosting more popular files.

The storage nodes each require adequate disk capacity and network connectivity, and may also have CPU or modest GPU acceleration if local data processing or chunk verification is performed. Edge or cloud servers can be used to host the AFLE—though it may also be distributed—along with higher-level analytics for load forecasting, and should contain sufficient processing power (e.g., multi-core CPUs) for fuzzy logic inference and real-time data aggregation, especially if the network is large. A fuzzy inference library (Python- or C++-based, for instance) implements the membership functions and rules, while orchestration software (for example, containerized microservices running Docker/Kubernetes or specialized blockchain-based service layers) coordinates block movement and replication. Agent software or custom protocols on each node supply disk and bandwidth metrics to the AFLE, and reliable messaging frameworks (MQTT, gRPC, or custom P2P protocols) broadcast updated data placement instructions to the relevant nodes.

First, nodes continuously report disk/bandwidth metrics to the central or distributed fuzzy logic engine. Next, the AFLE evaluates membership function sets for “storage status,” “replication factor,” and “retrieval performance,” producing a fuzzy classification and triggering rule evaluation to determine which nodes are best suited for replicating or serving the data. Once a decision is reached, the AFLE outputs block placement or replication targets to the distributed orchestration module. The orchestration module then sends commands to move, replicate, or reduce copies of data blocks among nodes, thus implementing the fuzzy logic guidance in near real time. Finally, as the network evolves (due to node churn, new node additions, or shifts in regional usage) the AFLE membership functions shift accordingly, forming a closed-loop arrangement that continuously optimizes data placement to ensure reliable storage and fast retrieval.

By maintaining this adaptive data placement scheme, the system addresses both resilience and responsiveness to changes in demand or node availability. Real-time fuzzy classification of node capabilities and user application patterns enables more efficient resource utilization and an overall improvement in Quality of Service (QOS) across the decentralized storage infrastructure.

In an illustrative deployment, the disclosed method for adaptively managing validator incentives and security in a proof-of-stake (PoS) or proof-of-authority (PoA) blockchain is implemented by a permissioned network (referred to here as “ProofChain”) that relies on a diverse set of validators. ProofChain's design aims to mitigate malicious or suboptimal validator behavior while ensuring fair reward distribution and stable chain operation.

First, ProofChain collects validator performance data from each node, drawing on metrics such as computational resource usage (e.g., CPU or memory load), missed block counts, and contradictory proposal events. These data points are broadcast or logged to a dedicated monitoring layer, where they are forwarded to an adaptive fuzzy logic engine (AFLE). The AFLE defines dynamic membership functions for at least (i) “validator efficiency” (reflecting resource consumption, block production consistency, or error rates) and (ii) “consensus participation” (capturing missed blocks, signing consistency, or contradictory proposals). As performance variations arise (whether from network congestion or a node's degraded hardware) the membership functions for efficiency and participation update in real time to reflect current conditions.

The AFLE next computes fuzzy inferences that assign each validator a real-time effectiveness or security posture score. For example, consistent missed blocks and contradictory proposals might degrade a validator's membership ranking under “consensus participation,” whereas high computational overhead (resource usage spikes) could lower its “validator efficiency” classification. If the fuzzy inference for a validator crosses a threshold indicative of consistent idleness, poor throughput, or malicious attempts to disrupt block production, the system automatically adjusts block reward parameters (e.g., reducing the node's portion of newly minted tokens) or imposes a slashing penalty. This approach prevents low-performing or malevolent validators from receiving an unearned share of rewards and helps maintain overall network stability.

Underpinning these adjustments is a learning module that analyzes historical validator outcomes-such as slashing incidents, error logs, and prior block production patterns—to refine the membership functions over time. If the module detects emerging behaviors that traditional static metrics might misinterpret, it reweights the fuzzy classification process to better capture those anomalies in the future. Consequently, validators engaging in borderline misconduct or novel exploit techniques can be identified more accurately, and honest validators are less likely to be penalized for transient or benign fluctuations.

Implementing this solution typically involves several hardware and software components. Each validator node runs specialized monitoring software to record resource consumption, block production, or other relevant metrics. These data streams are sent to a central aggregator or distributed oracle layer (depending on network design), which then feeds them into the AFLE. The AFLE itself may reside on a multi-core server or cluster with sufficient processing resources (CPU or GPU acceleration, if needed) to perform near-real-time fuzzy inference for the entire validator set. The learning module uses machine learning frameworks (e.g., scikit-learn, TensorFlow, or similar libraries) to detect patterns in historical data and fine-tune membership function boundaries. Finally, the blockchain protocol implements the resulting reward or slashing decisions via on-chain smart contracts or consensus-level rules, ensuring that performance-related adjustments are transparent and enforced uniformly across the network.

By pairing fuzzy logic classification with an iterative learning cycle, ProofChain aligns validator compensation with actual performance and trustworthiness. Poorly contributing or malicious participants face automatic penalties, while nodes maintaining consistent uptime and low error rates can earn proportionally higher rewards. This results in a robust, adaptive method for strengthening network security, optimizing block production, and fairly distributing rewards in a PoS or PoA blockchain environment.

In a representative scenario, the disclosed system for dynamically managing blockchain resources in a permissionless network is implemented by a large-scale public chain, referred to here as “ChainFlow.” This permissionless chain supports a diverse set of decentralized applications (dApps), from high-frequency trading protocols to NFT marketplaces, all of which generate unpredictable transaction volumes. ChainFlow's governance charter aims to balance user transaction throughput against the risk of mempool bottlenecks, ensuring that critical transactions are not delayed or priced out by sudden spikes in network activity.

To achieve this balance, ChainFlow integrates an adaptive fuzzy logic engine (AFLE) that continually monitors real-time blockchain metrics, including transaction backlogs, block production rates, and historical fee data. The AFLE uses dynamic membership functions to classify network load states, such as “low load,” “moderate load,” and “high congestion.” In practice, when the mempool or backlog grows beyond a certain threshold, the “high congestion” membership function expands or intensifies, indicating that the network risks overcrowding. Once this classification is made, fuzzy rule inferences direct the engine to recommend adjustments (such as raising block size or incrementing base transaction fees) to head off prolonged congestion and maintain stable block production times.

Behind the scenes, a learning module refines the AFLE's membership functions and fuzzy rules by analyzing historical on-chain events. For example, the module may discover that rapidly raising fees during specific time windows leads to only marginal reductions in mempool congestion, whereas incrementally expanding block size or block gas limits has proven more effective at certain traffic levels. The next time a similar usage pattern emerges (such as, for example, a surge in flash-loan arbitrage transactions), the learning module ensures that the fuzzy membership functions place higher weight on incremental block space increases, thereby mitigating congestion while minimizing disruptive fee swings.

A critical component for operationalizing these reconfigurations is the execution layer deployed on multiple validating nodes throughout the ChainFlow network. Each node receives the AFLE's reconfiguration commands, which may include directives to alter block gas limits, change priority fee levels, or throttle low-priority transactions. These updates are applied in substantially real time, ensuring that no single node's configuration lags behind the others and that consensus remains synchronized. By broadcasting the AFLE's decisions as standardized messages or smart contract calls, the system prevents forks or inconsistencies in chain logic, even as transaction rules or throughput parameters shift dynamically.

From a hardware perspective, the AFLE may be hosted on a set of robust servers—potentially with multi-core CPUs or GPU acceleration to run the fuzzy inference processes and data analytics efficiently—although in certain designs, the engine can also be partially distributed among node operators. The learning module typically leverages machine learning libraries (such as scikit-learn, TensorFlow, or PyTorch) for iterative analysis of historical transaction throughput, mempool sizes, and block production logs. Finally, validator nodes require reliable network connectivity, a secure communication channel for receiving updates, and sufficient processing power to implement reconfiguration commands quickly. Integrating all these components in a closed-loop feedback system allows ChainFlow to manage blockchain resources in a fine-grained manner, reducing transaction latency under high load while preserving overall network performance in a permissionless environment.

In an exemplary deployment, the disclosed system for multi-layer blockchain coordination is utilized by a DeFi platform referred to here as “MultiDex,” which relies on both a Layer-1 (L1) mainnet (e.g., Ethereum) and a Layer-2 (L2) or sidechain (e.g., a rollup or sidechain specialized for faster transaction processing). MultiDex enables users to seamlessly move assets and interact with DeFi smart contracts across both layers.

To support this functionality, MultiDex deploys a cross-layer data aggregator that continuously collects operational metrics from both the L1 and L2, including gas fee levels, aggregator node status, and bridging throughput (for example, the rate at which tokens are moved between layers). These metrics are aggregated and normalized in near real time to provide a comprehensive view of each chain's current state. Specifically, the aggregator monitors gas fee spikes on either chain that may affect bridging costs, tracks transaction throughput and finality times on the L2, and measures how many cross-layer operations (such as deposits, withdrawals, or batch settlements) are pending, completed, or delayed.

A central or partially distributed adaptive fuzzy logic engine (AFLE) processes the metrics collected by the aggregator. Within the AFLE, layer-specific membership function subsets classify each chain's state, such as “low load,” “moderate load,” or “high congestion.” For instance, on the L1 side, a network load membership function might assess transaction volume and gas fees, while on the L2 side, the membership function could reflect aggregator throughput and block finality metrics. Each membership function subset updates dynamically in response to the latest data feeds from the aggregator.

Once the AFLE assigns fuzzy labels to both L1 and L2, a weighted aggregation mechanism interprets these labels to make unified decisions regarding bridging operations. For example, if L1 is highly congested while L2 remains relatively free, the AFLE might prioritize shifting user transactions to L2. Conversely, if the L2 aggregator is approaching saturation, the AFLE can reduce bridging frequency or batch size, thereby minimizing potential bottlenecks. These decisions draw on fuzzy rule sets that factor in bridging costs or throughput constraints on each layer, ensuring that bridging frequency and settlement batches remain dynamically aligned with real-time network conditions.

A distributed gateway layer then executes the AFLE's outputs in near real time by coordinating user deposits, L2 checkpointing to L1, or other bridging activities. In practice, this can mean increasing bridging frequency if the L2 becomes congested but L1 has unexpectedly low gas fees, or raising batch size on L1 if gas costs spike, thus reducing the number of individual transactions submitted in each block and allowing fees to be shared among a larger set of users.

From a hardware and software perspective, the cross-layer data aggregator typically operates on robust servers capable of polling multiple nodes or chain explorers and normalizing the resulting metrics. The AFLE may run on dedicated hardware with sufficient CPU or GPU resources to manage high-frequency fuzzy inferences, using fuzzy logic libraries and, optionally, a machine learning module (e.g., scikit-learn or TensorFlow) to refine membership function parameters over time. Meanwhile, the distributed gateway nodes require secure messaging protocols (such as gRPC or libp2p) and adequate computing power to implement bridging decisions promptly without hampering consensus. Containerization frameworks (e.g., Docker or Kubernetes) can help to scale aggregator and AFLE services as network usage fluctuates.

In an end-to-end interaction flow, the aggregator first collects L1 gas fees, L2 aggregator throughput, and bridging statistics, pushing these metrics to the AFLE. Next, the AFLE's layer-specific membership functions classify each layer's network conditions, and the weighted aggregation mechanism decides how bridging or batch confirmations should be adjusted based on which layer is more heavily loaded. The distributed gateway layer then executes these bridging schedules or batch size modifications, with the system's learning module analyzing real-world data over time to refine membership function boundaries and rules in response to evolving chain load patterns.

By coordinating bridging and settlement frequencies in accordance with the AFLE's dynamic fuzzy classifications of each chain's resource constraints, MultiDex ensures that users benefit from faster, cheaper transactions on L2 while retaining the security of finality on L1. This multi-layer arrangement maintains balanced throughput without resorting to static bridging intervals or uniform batch sizes, thereby enhancing the reliability and cost-effectiveness of cross-layer DeFi services.

The above description of the present invention is illustrative and is not intended to be limiting. It will thus be appreciated that various additions, substitutions and modifications may be made to the above described embodiments without departing from the scope of the present invention. Accordingly, the scope of the present invention should be construed in reference to the appended claims. It will also be appreciated that the various features set forth in the claims may be presented in various combinations and sub-combinations in future claims without departing from the scope of the invention. In particular, the present disclosure expressly contemplates any such combination or sub-combination that is not known to the prior art, as if such combinations or sub-combinations were expressly written out.

1. A system for managing Internet of Things (IoT) networks, comprising:
a network performance monitor configured to collect real-time data on network performance metrics and contextual information;
an adaptive fuzzy logic engine (AFLE) configured to utilize dynamic membership functions for decision-making regarding network management tasks based on input from the network performance monitor;
a learning module configured to adapt the membership functions and rules of the AFLE based on the outcomes of decisions to optimize future network performance; and
an action executor configured to implement the decisions made by the AFLE to adjust network configurations.

2. The system of claim 1, wherein the network performance metrics include at least one metric selected from the group consisting of latency, bandwidth utilization, packet loss rates, and device connectivity status.

3. The system of claim 1, wherein the contextual information includes information selected from the group consisting of device density, time-of-day usage patterns, and historical network performance data.

4. The system of claim 1, wherein the dynamic membership functions are configured to adjust shapes and parameters based on real-time data collected by the network performance monitor.

5. The system of claim 1, wherein the learning module employs online learning algorithms to optimize the parameters of the dynamic membership functions.

6. The system of claim 1, wherein the learning module employs evolutionary strategies to optimize the parameters of the dynamic membership functions.

7. The system of claim 1, wherein the adaptive fuzzy logic engine (AFLE) is further configured to evaluate network conditions using a set of fuzzy logic rules that adjust dynamically based on the adaptive membership functions.

8. The system of claim 1, wherein the action executor is configured to adjust at least one item selected from the group consisting of routing of data packets, allocation of bandwidth, and prioritization of devices, based on their needs and the overall state of the network.

9. The system of claim 1, further comprising a user interface module configured to present the network performance data and decisions made by the AFLE in a user-accessible format.

10. The system of claim 1, wherein the AFLE further incorporates neural network components to form a neuro-fuzzy system for enhanced decision-making capability.

11. The system of claim 1, wherein the adaptive fuzzy logic engine (AFLE) is configured to perform cross-layer data analysis by integrating data from the physical layer, data link layer, network layer, transport layer, and application layer to inform decision-making processes, thereby enabling a comprehensive understanding of network conditions across multiple layers.

12. The system of claim 1, further comprising a mechanism for dynamic adjustment of network configurations based on cross-layer feedback, wherein said adjustments include changes to routing protocols, bandwidth allocation, and Quality of Service (QoS) parameters to optimize network performance and resilience based on integrated feedback from multiple network layers.

13. The system of claim 1, wherein the learning module utilizes predictive analytics models that forecast future network conditions and potential issues by analyzing historical and real-time data across the physical layer, data link layer, network layer, transport layer, and application layer, thereby allowing for proactive adjustments to network configurations.

14. The system of claim 1, further comprising a cross-layer security management feature, wherein the system identifies and mitigates security threats by analyzing anomalies and patterns of behavior across a plurality of network layers to ensure comprehensive network security.

15. The system of claim 14, wherein said plurality of network layers are selected from the group consisting of the physical layer, data link layer, network layer, and application layer.

16. The system of claim 1, wherein the system operates to improve energy efficiency across multiple network layers through adjustments to power output at the physical layer, optimization of data link layer protocols for low-energy operation, energy-efficient routing at the network layer, and management of application layer processes to reduce unnecessary data transmissions, thereby enhancing the overall energy efficiency of the IoT network.

17. The system of claim 1, wherein the learning module incorporates Particle Swarm Optimization (PSO) algorithms to optimize the parameters of the dynamic membership functions across multiple network layers, including the physical layer, data link layer, network layer, transport layer, and application layer, based on a comprehensive objective function that assesses network performance, energy efficiency, and security posture.

18. The system of claim 1, further comprising utilizing PSO for dynamically adjusting network configurations in real-time, where PSO algorithms analyze the collective impact of changes across multiple network layers to identify optimal configurations that meet predefined network performance goals.

19. The system of claim 1, wherein PSO is employed to enhance cross-layer security measures, dynamically adjusting security protocols and configurations across the network layers in response to detected threats and vulnerabilities, based on risk assessments calculated through PSO algorithms.

20. The system of claim 1, wherein PSO is applied to optimize energy consumption across IoT devices and network infrastructure, leveraging cross-layer data to dynamically adjust power settings, operational modes, and routing protocols to achieve optimal energy efficiency without compromising network performance or reliability.

21-331. (canceled)
